(19) United States
(12) Patent Application Publication
(10) Pub. No.: US 2026/0343670 A1
(43) Pub. Date: Oct. 29, 2026

(54) METHOD AND APPARATUS FOR ENERGY SAVING IN WIRELESS COMMUNICATION SYSTEM

(71) Applicant: Samsung Electronics Co., Ltd., Suwon-si, Gyeonggi-do (KR)

(72) Inventors: Sa ZHANG, Beijing (CN); Feifei SUN, Beijing (CN); Zhe CHEN, Beijing (CN)

(21) Appl. No.: 19/485,519

(22) PCT Filed: May 17, 2024
(86) PCT No.: PCT/KR2024/095794

§ 371 Date: Nov. 18, 2025

(30) Foreign Application Priority Data
May 19, 2023 (CN) 202310574371.X
May 29, 2023 (CN) 202310620370.4
Aug. 9, 2023 (CN) 202311000851.1
Sep. 27, 2023 (CN) 202311267361.8
Feb. 8, 2024 (CN) 202410178300.2

(51) Int. Cl. H04W 76/28

(52) U.S. Cl. CPC H04W 76/28

(57) ABSTRACT

The disclosure relates to a 5G or 6G communication system for supporting a higher data transmission rate. Provided are a method and an apparatus for energy saving in a wireless communication system. The method includes receiving, via higher layer signaling, a first configuration of at least one of cell discontinuous transmission (DTX) or cell discontinuous reception (DRX) and a second configuration of a bit position associated with information of downlink control information (DCI); receiving the DCI; and identifying the information from the DCI based on the second configuration, wherein the information indicates activation or deactivation of the at least one of the cell DTX or the cell DRX configured by the first configuration.

### TECHNICAL FIELD

The disclosure relates to wireless communication technology, and more specifically, to a method and an apparatus for energy saving in a wireless communication system.

### BACKGROUND ART

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The disclosure may provide a method and an apparatus for energy saving in a wireless communication system.

The technical objects to be achieved by various embodiments of the disclosure are not limited to the technical objects mentioned above, and other technical objects not mentioned may be considered by those skilled in the art from various embodiments of the disclosure to be described below.

### Solution to Problem

According to some aspects of the disclosure, a method performed by a terminal in a wireless communication system is provided. The method includes: receiving downlink data and/or first information, wherein the first information indicates information related to cell discontinuous reception and/or cell discontinuous transmission; generating hybrid automatic repeat request-acknowledgement (HARQ-ACK) information for the downlink data and/or the first information, wherein the information related to cell discontinuous reception and/or cell discontinuous transmission is applied after transmitting an uplink channel carrying the HARQ-ACK information including an acknowledgement (ACK), and wherein the uplink channel is not cancelled.

In combination with one or more aspects of the method performed by the terminal described above, for example, the information related to cell discontinuous reception and/or cell discontinuous transmission is applied after a first number of time units after transmitting the uplink channel; or the information related to cell discontinuous reception and/or cell discontinuous transmission is applied in a cycle related to discontinuous reception and/or cell discontinuous transmission after the first number of time units after transmitting the uplink channel.

In combination with one or more aspects of the method performed by the terminal described above, for example, the method further includes in case that the HARQ-ACK information includes a negative acknowledgement (NACK): monitoring a physical downlink control channel (PDCCH) after transmitting the uplink channel, and/or starting a first timer after transmitting the uplink channel, wherein the first timer is used to indicate one or more of a time that the terminal monitors the PDCCH or an active period of the terminal.

In combination with one or more aspects of the method performed by the terminal described above, for example, in case that the HARQ-ACK information includes a NACK: the PDCCH is monitored after a second number of time units after transmitting the uplink channel, and/or the first timer after the second number of time units is started after transmitting the uplink channel.

In combination with one or more aspects of the method performed by the terminal described above, for example, the method further includes starting a second timer after transmitting the uplink channel, wherein the second timer is used to indicate a time that the terminal waits for to receive the PDCCH, wherein the first timer is started when the second timer expires.

In combination with one or more aspects of the method performed by the terminal described above, for example, the NACK includes one or more of: a NACK corresponding to a transport block or a code block group; a NACK corresponding to a physical downlink shared channel (PDSCH); a NACK corresponding to a PDSCH that is not received; a NACK generated for a missing downlink control information (DCI) format; a NACK included in a HARQ-ACK codebook; or a NACK other than padded NACKs.

In combination with one or more aspects of the method performed by the terminal described above, for example, in case that a Type-2 HARQ-ACK codebook is configured, the NACK generated for the missing DCI format may include one or more of the following: a NACK generated based on a counter downlink allocation index (C-DAI) being discontinuous; a NACK generated based on a value of a C-DAI in a last downlink (DL) DCI format among one or more DL DCI formats being not equal to a value of a total DAI (T-DAI), where the one or more DL DCI formats are received in any PDCCH monitoring occasion; a NACK generated based on a value of a C-DAI in a last DL DCI format among one or more DL DCI formats being not equal to a value of an uplink (UL) T-DAI, where the one or more DL DCI formats are received in a last PDCCH monitoring occasion; or a NACK generated based on a value of a T-DAI in a DL DCI format received in the last PDCCH monitoring occasion being not equal to a value of a UL T-DAI.

In combination with one or more aspects of the method performed by the terminal described above, for example, the last DL DCI format is a DL DCI format with a largest index of a serving cell among the one or more DL DCI formats received in the PDCCH monitoring occasion, wherein the serving cell is a serving cell where a PDSCH scheduled by the DL DCI format is located.

In combination with one or more aspects of the method performed by the terminal described above, for example, the UL T-DAI is a UL T-DAI in a DCI format that schedules a physical uplink shared channel (PUSCH) carrying the HARQ-ACK information.

In connection with one or more aspects of the method performed by the terminal described above, for example, the first information is carried by a downlink channel, wherein the information related to cell discontinuous reception and/or cell discontinuous transmission is applied after receiving the downlink channel.

In combination with one or more aspects of the method performed by the terminal described above, for example, the information related to cell discontinuous reception and/or cell discontinuous transmission is applied in a cycle related to discontinuous reception and/or cell discontinuous transmission after a third number of time units after receiving the downlink channel; or the information related to cell discontinuous reception and/or cell discontinuous transmission is applied after the third number of time units after receiving the downlink channel.

In combination with one or more aspects of the method performed by the terminal described above, for example, the information related to cell discontinuous reception and/or cell discontinuous transmission includes one or more of: first indication information that is used to indicate activation and/or deactivation of cell discontinuous reception and/or cell discontinuous transmission; second indication information that is used to indicate modification of a parameter related to cell discontinuous reception and/or cell discontinuous transmission; or third indication information that is used to indicate whether to start a third timer of next one or more cycles related to cell discontinuous reception and/or cell discontinuous transmission.

In connection with one or more aspects of the method performed by the terminal described above, for example, the first information is carried by a downlink channel, which includes a PDCCH and/or a PDSCH, wherein the uplink channel includes a physical uplink control channel (PUCCH) and/or a PUSCH.

According to some aspects of the disclosure, a method performed by a base station in a wireless communication system is provided. The method includes: transmitting downlink data and/or first information to a terminal, wherein the first information indicates information related to cell discontinuous reception and/or cell discontinuous transmission; and receiving an uplink channel from the terminal, wherein the uplink channel carries hybrid automatic repeat request-acknowledgem ent (HARQ-ACK) information including an acknowledgement (ACK), wherein the HARQ-ACK information is generated based on the downlink data and/or the first information, wherein the information related to cell discontinuous reception and/or cell discontinuous transmission is applied after an uplink channel carrying the HARQ-ACK information including an acknowledgement (ACK) is transmitted by the terminal, and wherein the uplink channel is not cancelled.

In combination with one or more aspects of the method performed by the base station described above, for example, the information related to cell discontinuous reception and/or cell discontinuous transmission is applied in a cycle related to discontinuous reception and/or cell discontinuous transmission after a first number of time units after the uplink channel is transmitted by the terminal.

In connection with one or more aspects of the method performed by the base station described above, for example, the first information is carried by a downlink channel, wherein the information related to cell discontinuous reception and/or cell discontinuous transmission is applied after the downlink channel is received by the terminal.

In combination with one or more aspects of the method performed by the base station described above, for example, the information related to cell discontinuous reception and/or cell discontinuous transmission is applied in a cycle related to discontinuous reception and/or cell discontinuous transmission after a third number of time units after the downlink channel is received by the terminal; or the information related to cell discontinuous reception and/or cell discontinuous transmission is applied after the third number of time units after the downlink channel is received by the terminal.

In combination with one or more aspects of the method performed by the base station described above, for example, the information related to cell discontinuous reception and/or cell discontinuous transmission includes one or more of: first indication information that is used to indicate activation and/or deactivation of cell discontinuous reception and/or cell discontinuous transmission; second indication information that is used to indicate modification of a parameter related to cell discontinuous reception and/or cell discontinuous transmission; or third indication information that is used to indicate whether to start a third timer of next one or more cycles related to cell discontinuous reception and/or cell discontinuous transmission.

In connection with one or more aspects of the method performed by the base station described above, for example, the first information is carried by a downlink channel, which includes a PDCCH and/or a PDCCH, wherein the uplink channel includes a physical uplink control channel (PUCCH) and/or a physical uplink shared channel (PUSCH).

According to some aspects of the disclosure, there is also provided a terminal in a wireless communication system. The terminal includes a transceiver, and one or more processors coupled with the transceiver and configured to perform one or more aspects of the above-mentioned methods performed by the terminal.

According to some aspects of the disclosure, there is also provided a base station in a wireless communication system. The base station includes a transceiver, and one or more processors coupled with the transceiver and configured to perform one or more aspects of the methods performed by the base station.

According to some aspects of the disclosure, there is also provided a computer-readable storage medium on which one or more computer programs are stored, wherein one or more aspects of the above-described methods performed by a terminal can be implemented when the one or more computer programs are performed by one or more processors.

According to some aspects of the disclosure, there is also provided a computer-readable storage medium on which one or more computer programs are stored, wherein one or more aspects of the above-described methods performed by a base station can be implemented when the one or more computer programs are performed by one or more processors.

The above-described various embodiments of the disclosure are merely some of the preferred embodiments of the disclosure, and various embodiments reflecting the technical features of the disclosure may be derived and understood by those skilled in the art based on the following detailed description of the disclosure.

### Advantageous Effects of Invention

The disclosure may provide a method and an apparatus for energy saving in a wireless communication system.

The effects that can be achieved through the disclosure are not limited to the effects mentioned in the various embodiments, and other effects not mentioned will be clearly understood by those skilled in the art from the description below.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure, in which:

FIG. 1 illustrates a schematic diagram of an example wireless network according to some embodiments of the disclosure;

FIG. 2A illustrates an example wireless transmission path according to some embodiments of the disclosure;

FIG. 2B illustrates an example wireless reception path according to some embodiments of the disclosure;

FIG. 3A illustrates an example user equipment (UE) according to some embodiments of the disclosure;

FIG. 3B illustrates an example gNB according to some embodiments of the disclosure;

FIG. 4 illustrates a block diagram of a first transceiving node according to some embodiments of the disclosure;

FIG. 5 illustrates a block diagram of a second transceiving node according to some embodiments of the disclosure;

FIG. 6 illustrates a flowchart of a method performed by a base station according to some embodiments of the disclosure;

FIG. 7 illustrates a flowchart of a method performed by a UE according to some embodiments of the disclosure;

FIG. 8A illustrates an example of uplink transmission timing according to some embodiments of the disclosure;

FIG. 8B illustrates an example of uplink transmission timing according to some embodiments of the disclosure;

FIG. 8C illustrates an example of uplink transmission timing according to some embodiments of the disclosure;

FIG. 9A illustrates an example of time domain resource allocation tables according to some embodiments of the disclosure;

FIG. 9B illustrates an example of time domain resource allocation tables according to some embodiments of the disclosure;

FIG. 10 illustrates a flowchart of a method performed by a terminal according to some embodiments of the disclosure; and

FIG. 11 illustrates a flowchart of a method performed by a base station according to some embodiments of the disclosure.

### MODE FOR THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

In the description of the example embodiments of the disclosure, “/” means “and/or”. For example, “A/B” may refer to “A and/or B”.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In the disclosure, to determine whether a specific condition is satisfied or fulfilled, expressions, such as “greater than/larger than” or “less than/smaller than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies.

Hereinafter, the embodiments of the disclosure will be described in detail with reference to the accompanying drawings. It should be noted that the same reference numerals in different drawings will be used to refer to the same elements already described.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

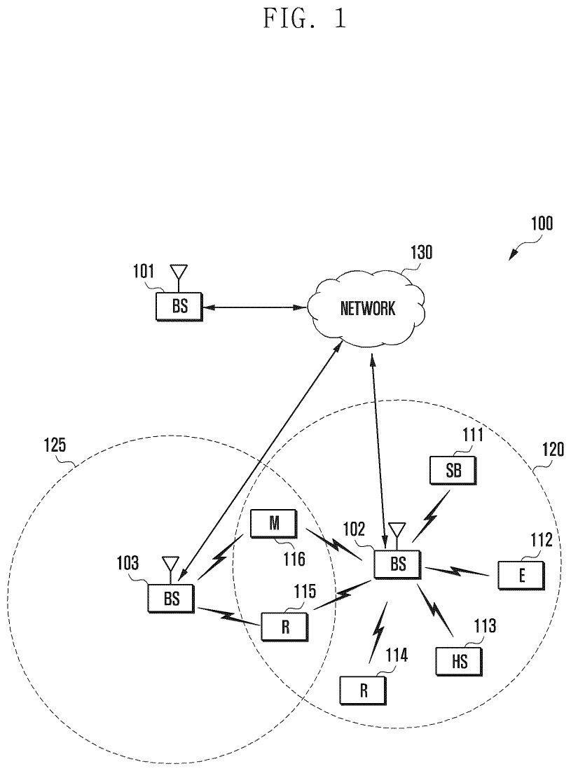

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some implementations, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some implementations, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

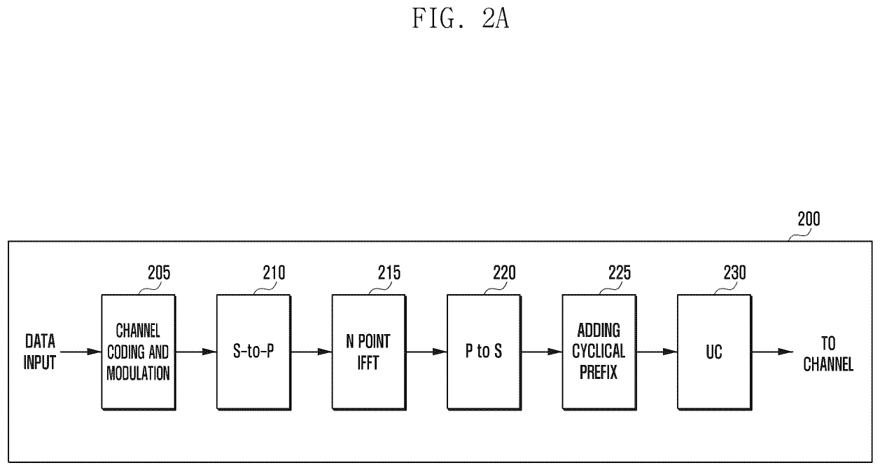

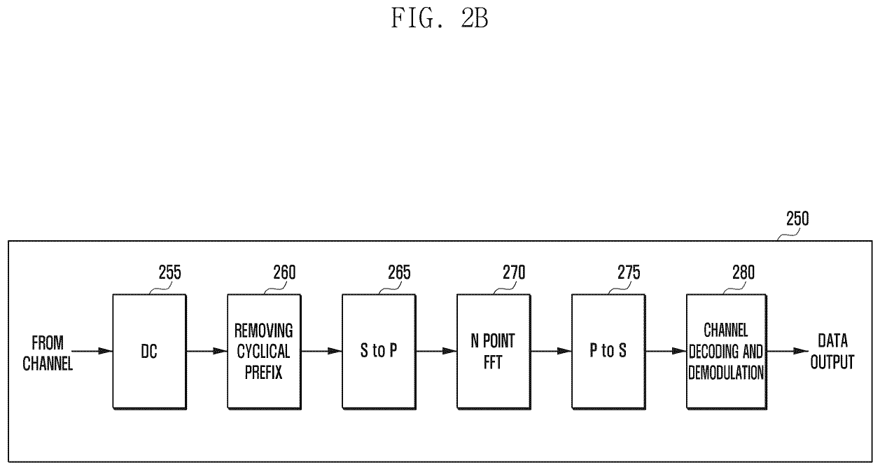

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some implementations, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

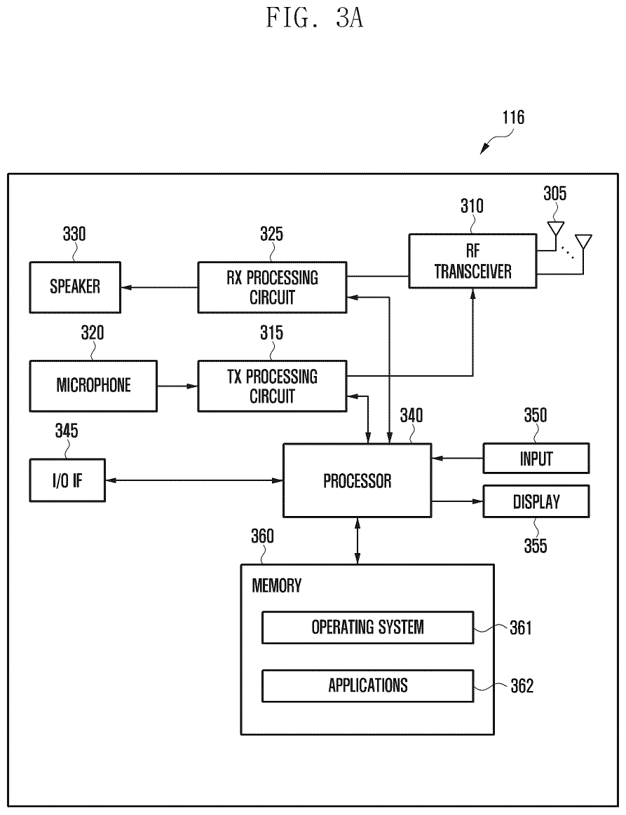

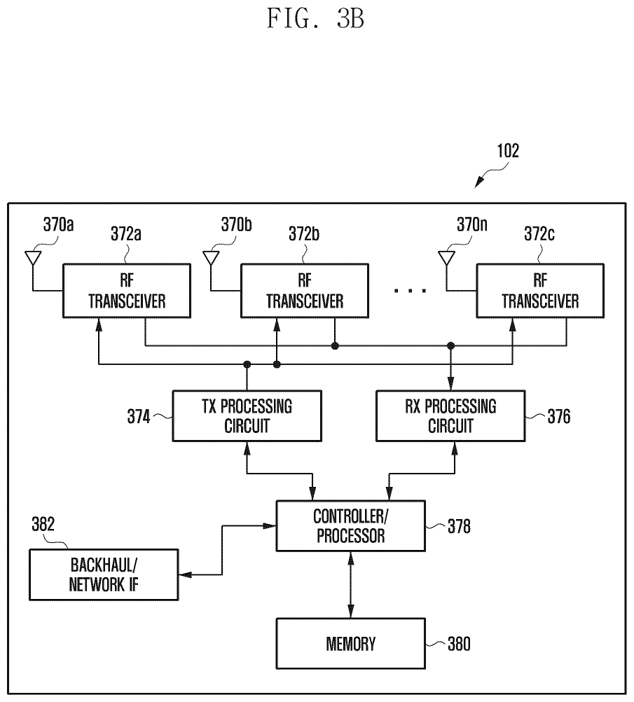

FIG. 3A illustrates an example UE 116 according to some embodiments of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some implementations, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some implementations, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

In some implementations, two or more UEs 116 may communicate directly using one or more sidelink channels (for example, without using a base station as a medium for communication with each other). For example, the UE 116 may communicate using peer-to-peer (P2P) communication, device-to-device (D2D) communication, vehicle-to-everything (V2X) protocol (which, for example, may include vehicle-to-vehicle (V2V) protocol, vehicle-to-infrastructure (V2I) protocol, etc.), mesh network, etc. In this case, the UE 116 may perform scheduling operations, resource selection operations, and/or other operations performed by the base station as described elsewhere herein. For example, the base station may configure the UE 116 via downlink control information (DCI), radio resource control (RRC) signaling, medium access control-control element (MAC-CE) or via system information (e.g., system information block (SIB)).

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some implementations, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some implementations, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a PCS (personal communications service), which may combine voice, data processing, fax and/or data communication capabilities; a PDA (Personal Digital Assistant), which may include a radio frequency receiver, a pager, an internet/intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (Mobile Internet Device) and/or a mobile phone with music/video playing functions, a smart TV, a set-top box and other devices.

With the rapid development of information industry, especially the increasing demand from mobile Internet and internet of things (IoT), it brings unprecedented challenges to the future mobile communication technology. In order to meet the unprecedented challenges, the communication industry and academia have carried out extensive research on the fifth generation (5G) mobile communication technology to face the 2020s. At present in ITU report ITU-R M. [IMT.VISION], the framework and overall goals of the future 5G has been discussed, in which the demand outlook, application scenarios and important performance indicators of 5G are described in detail. With respect to new requirements in 5G, ITU report ITU-R M. [IMT.FUTURE TECHNOLOGY TRENDS] provides information related to the technology trends of 5G, aiming at solving significant problems such as significantly improved system throughput, consistent user experience, scalability to support IoT, delay, energy efficiency, cost, network flexibility, support of emerging services and flexible spectrum utilization. In 3GPP (3rd Generation Partnership Project), the first stage of 5G is already in progress. To support more flexible scheduling, the 3GPP decides to support variable hybrid automatic repeat request-acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, a HARQ-ACK feedback delay is determined for a corresponding downlink subframe based on an uplink and downlink configuration. In 5G systems, whether FDD or TDD systems, for a determined downlink time unit (for example, a downlink slot or a downlink mini slot; for another example, a PDSCH time unit), the uplink time unit (for example, a PUCCH time unit) that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-eMBB (enhanced mobile broadband), mMTC (massive machine-type communication) and URLLC (ultra-reliable and low-latency communication). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

In some cases, the network does not transmit or receive data or control information for a period of time in order to save energy/power. How to indicate to the UE whether the network transmits or receives data or control information is a problem to be solved. Therefore, an enhanced downlink signal receiving and uplink signal transmitting method of the UE is needed to reduce the power consumption of the UE.

In order to at least solve the above technical problems, example embodiments of the disclosure provide a method performed by a terminal, a terminal, a method performed by a base station, a base station and a non-transitory computer-readable storage medium in a wireless communication system. Hereinafter, various example embodiments of the disclosure will be described in detail with reference to the accompanying drawings.

In the example embodiments of the disclosure, for the convenience of description, a first transceiving node and a second transceiving node are defined. For example, the first transceiving node may be a base station, and the second transceiving node may be a UE. For another example, the example embodiments of the disclosure may be applicable to the scenario of sidelink communication, in which case, the first transceiving node may be a UE, and the second transceiving node may be another UE. Therefore, the first transceiving node and the second transceiving node may each be any suitable communication node. In the following description, the base station is taken as an example (but not limited thereto) to illustrate the first transceiving node, and the UE is taken as an example (but not limited thereto) to illustrate the second transceiving node.

In describing a wireless communication system and in the disclosure described below, transferring methods (or configuration methods) of higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (CE).

In the following description of the example embodiments of the disclosure, higher layer signaling may be signaling corresponding to at least one or a combination of one or more of the following signaling.
MIB (master information block)
SIB (system information block) or SIB X (X=1, 2, . . . )
RRC signaling
MAC CE

Physical layer (Layer 1 (L1)) signaling may be signaling corresponding to at least one or a combination of one or more of the following signaling.
PDCCH (physical downlink control channel)
DCI (downlink control information)
UE-specific DCI
group common DCI
common DCI
scheduling DCI (for example, DCI for scheduling downlink or uplink data)
non-scheduling DCI (for example, DCI other than DCI for scheduling downlink or uplink data)
PUCCH (physical uplink control channel)
UCI (uplink control information)

In the example embodiments of the disclosure, uplink control signaling may include physical layer signaling and/or higher layer signaling. As described above, the physical layer signaling may include UCI and/or PUCCH, and the higher layer signaling may include RRC signaling and/or a MAC CE.

In the example embodiments of the disclosure, downlink control signaling may include physical layer signaling and/or higher layer signaling. As mentioned above, the physical layer signaling may include one or more of PDCCH, DCI, UE-specific DCI, group common DCI, common DCI, scheduling DCI (for example, DCI for scheduling downlink or uplink data), and non-scheduling DCI, and the higher layer signaling may include one or more of a MIB, a SIB or SIB X (X=1, 2, . . . ), RRC signaling or a MAC CE. Therefore, “configuring or indicating X through downlink control signaling” will be understood as configuring or indicating X through physical layer signaling, or configuring or indicating X through higher layer signaling, or configuring or indicating X through a combination of higher layer signaling and physical layer signaling.

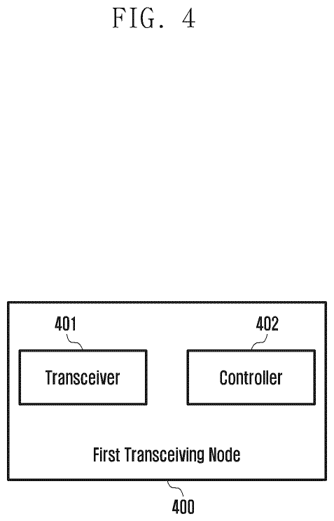

FIG. 4 illustrates a block diagram of a first transceiving node 400 according to some example embodiments of the disclosure.

Referring to FIG. 4, the first transceiving node 400 may include a transceiver 401 and a controller 402.

The transceiver 401 may be configured to transmit first data and/or first control signaling to a second transceiving node, and/or receive second data and/or second control signaling from the second transceiving node in a time unit.

The controller 402 may be an application specific integrated circuit or at least one processor. The controller 402 may be configured to control the overall operation of the first transceiving node 400, including controlling the transceiver 401 to transmit the first data and/or the first control signaling to the second transceiving node, and/or receive the second data and/or the second control signaling from the second transceiving node in the time unit.

In some implementations, the controller 402 may be configured to perform one or more of operations in methods of various example embodiments described below, for example, operations that can be performed by a base station.

In the following description, the base station is taken as an example (but not limited thereto) to illustrate the first transceiving node, and the UE is taken as an example (but not limited thereto) to illustrate the second transceiving node. Downlink data (but not limited thereto) is used to illustrate the first data. Downlink control signaling (but not limited thereto) is used to illustrate the first control signaling. Uplink control signaling (but not limited thereto) is used to illustrate the second control signaling. Uplink data (but not limited thereto) is used to illustrate the second data.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a WiFi access point (AP), or other wireless network devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

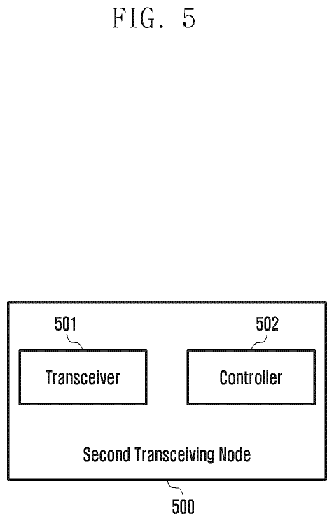

FIG. 5 illustrates a block diagram of a second transceiving node according to some embodiments of the disclosure.

Referring to FIG. 5, the second transceiving node 500 may include a transceiver 501 and a controller 502.

The transceiver 501 may be configured to receive first data and/or first control signaling from the first transceiving node, and transmit second data and/or second control signaling to the first transceiving node in a determined time unit.

The controller 502 may be an application specific integrated circuit or at least one processor. The controller 502 may be configured to control the overall operation of the second transceiving node and control the second transceiving node to implement the methods proposed in the example embodiments of the disclosure. For example, the controller 502 may be configured to determine the second data and/or the second control signaling and a time unit for transmitting the second data and/or the second control signaling based on the first data and/or the first control signaling, and control the transceiver 501 to transmit the second data and/or the second control signaling to the first transceiving node in the determined time unit.

In some implementations, the controller 502 may be configured to perform one or more of operations in methods of various example embodiments described below, for example, operations that can be performed by a terminal (UE).

In implementations described in connection with FIG. 4 or 5, the first data may be data transmitted by the first transceiving node to the second transceiving node. In the following examples, downlink data carried by a PDSCH (Physical Downlink Shared Channel) is taken as an example (but not limited thereto) to illustrate the first data.

In implementations described in connection with FIG. 4 or 5, the second data may be data transmitted by the second transceiving node to the first transceiving node. In the following examples, uplink data carried by a PUSCH (Physical Uplink Shared Channel) is taken as an example (but not limited thereto) to illustrate the second data.

In implementations described in connection with FIG. 4 or 5, the first control signaling may be control signaling transmitted by the first transceiving node to the second transceiving node. In the following examples, downlink control signaling is taken as an example (but not limited thereto) to illustrate the first control signaling. The downlink control signaling may be DCI (downlink control information) carried by a PDCCH (Physical Downlink Control Channel) and/or control signaling carried by a PDSCH (Physical Downlink Shared Channel). For example, the DCI may be UE specific DCI, and the DCI may also be common DCI. The common DCI may be DCI common to a part of UEs, such as group common DCI, and the common DCI may also be DCI common to all of UEs in a serving cell (e.g., cell common DCI). The DCI may also be multicast DCI or broadcast DCI. The DCI may be uplink DCI (e.g., DCI for scheduling a PUSCH) and/or downlink DCI (e.g., DCI for scheduling a PDSCH).

It should be noted that in the description of the example embodiments of the disclosure, the following terms may be used interchangeably:
DCI
DCI format
PDCCH
grant
dynamic grant.

In implementations described in connection with FIG. 4 or 5, the second control signaling may be control signaling transmitted by the second transceiving node to the first transceiving node. In the following examples, uplink control signaling is taken as an example (but is not limited thereto) to illustrate the second control signaling. The uplink control signaling may be UCI (Uplink Control Information) carried by a PUCCH (Physical Uplink Control Channel) and/or control signaling carried by a PUSCH (Physical Uplink Shared Channel). A type of UCI may include one or more of: HARQ-ACK information, SR (Scheduling Request), LRR (Link Recovery Request), CSI (Chanel State Information), UTO (unused transmission occasion)-UCI, or CG (Configured Grant) UCI. In the example embodiments of the disclosure, when UCI is carried by a PUCCH, the UCI may be used interchangeably with the PUCCH.

In some implementations, a PUCCH with an SR may be a PUCCH with a positive SR and/or a negative SR. The SR may be the positive SR and/or the negative SR.

In some implementations, the CSI report may be Part 1 CSI and/or Part 2 CSI.

In implementations described in connection with FIG. 4 or 5, a time unit in which the first transceiving node transmits the first data and/or the first control signaling is a first time unit. In some examples, the first time unit may be described by taking a downlink time unit or a downlink slot as an example (but not limited thereto).

In implementations described in connection with FIG. 4 or 5, a time unit in which the second transceiving node transmits the second data and/or the second control signaling may be an uplink time unit. In some examples, the second time unit may be described by taking an uplink slot or PUCCH slot or PCell (primary cell) slot or PUCCH slot on PCell as an example (but not limited thereto). The “PUCCH slot” may be understood as a PUCCH transmission slot.

In the example embodiments of the disclosure, a time unit (for example, a first time unit or a second time unit) may be one or more slots, one or more subslots, one or more OFDM symbols, one or more spans, or one or more subframes.

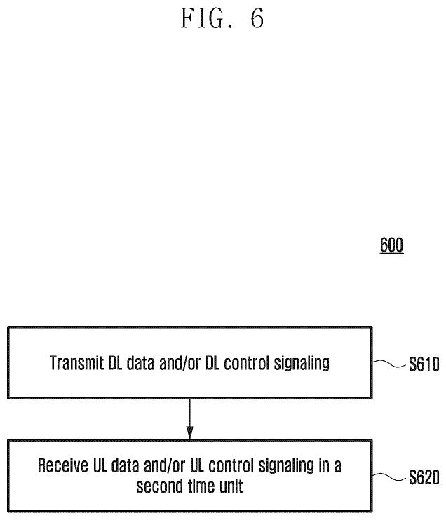

FIG. 6 illustrates a flowchart of a method 600 performed by a base station according to some embodiments of the disclosure.

Referring to FIG. 6, in operation S610, the base station transmits downlink data and/or downlink control signaling.

In operation S620, the base station receives the uplink data and/or the uplink control information from the UE in a second time unit.

In some implementations, operations S610 and/or S620 may be performed based on the methods described according to various example embodiments of the disclosure (e.g., various methods/manners described below).

In some implementations, the method 600 may omit one or more of operation S610 or S620, or may include additional operations, for example, the operations performed by the base station based on the methods described according to various example embodiments of the disclosure (e.g., various methods/manners described below).

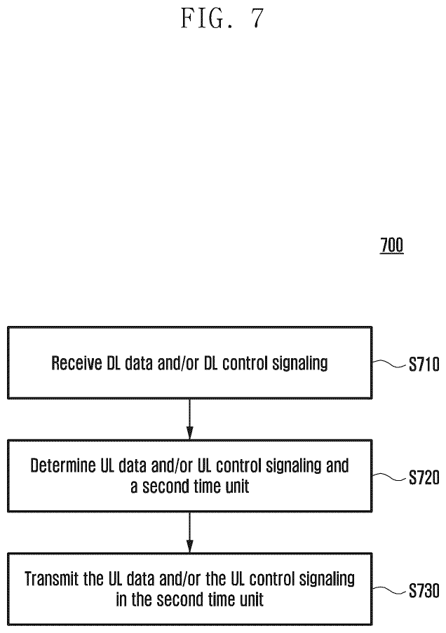

FIG. 7 illustrates a flowchart of a method 700 performed by a UE according to example embodiments of the disclosure.

Referring to FIG. 7, in operation S710, the UE may receive downlink (DL) data (e.g., downlink data carried by a PDSCH) and/or downlink control signaling from a base station. For example, the UE may receive the downlink data and/or the downlink control signaling from the base station based on predefined rules and/or received configuration parameters.

In operation S720, the UE determines uplink (UL) data and/or uplink control signaling, and a second time unit based on the downlink data and/or the downlink control signaling. For example, operation S720 may further include that the UE determine a transmission power of the uplink data and/or the uplink control signaling.

In operation S730, the UE transmits the uplink data and/or the uplink control signaling to the base station in the second time unit. For example, operation S730 may include that the UE transmits the uplink data and/or the uplink control signaling to the base station in the second time unit according to the determined transmission power.

In some implementations, operations S710 and/or S720 and/or S730 may be performed based on the methods described according to various example embodiments of the disclosure (e.g., various methods/manners described below).

In some implementations, the method 700 may omit one or more of operation S710, S720 or S730, or may include additional operations, for example, the operations performed by the UE (terminal) based on the methods described according to various example embodiments of the disclosure (e.g., various methods/manners described below).

In some implementations, acknowledgement/negative acknowledgement (ACK/NACK) for downlink transmission(s) may be performed through HARQ-ACK.

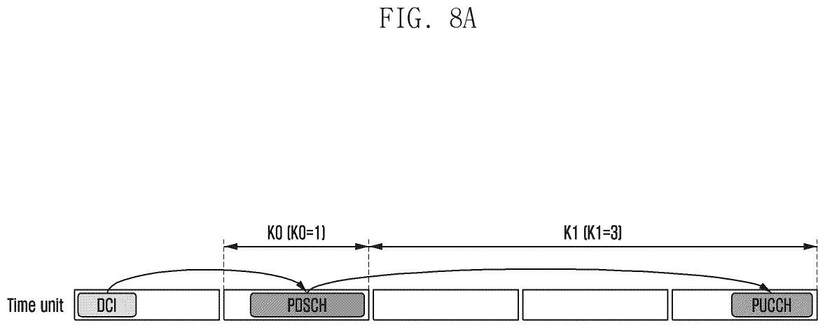

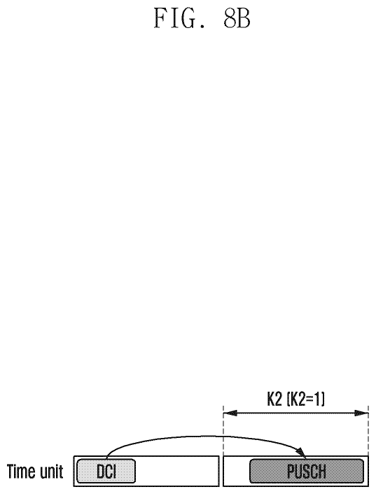

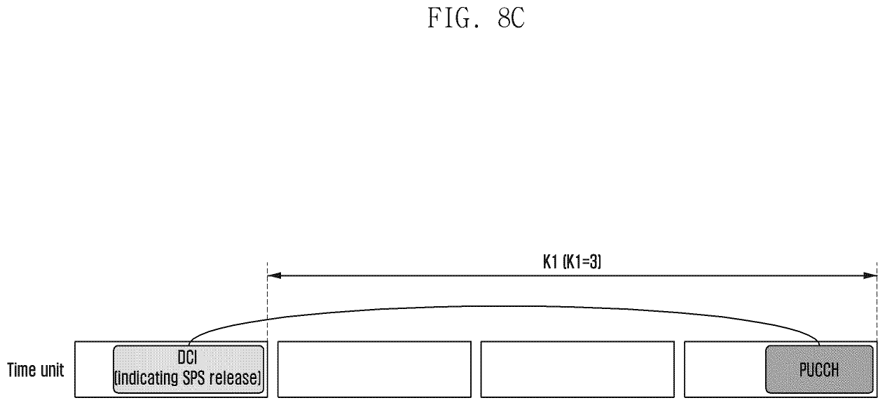

In some implementations, the downlink control signaling may include DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 8A-8C.

In an example, the UE receives a DCI format and receives a PDSCH according to time domain resources indicated by the DCI format. For example, a parameter K0 may be used to indicate a time interval (offset) between the PDSCH scheduled by the DCI format and the DCI format (e.g., a PDCCH carrying the DCI format), where K0 may be in units of slots. For example, FIG. 8A gives an example in which K0=1. In the example illustrated in FIG. 8A, the time interval from the PDSCH scheduled by the DCI format to the PDCCH carrying the DCI format is one slot. In the example embodiments of the disclosure, “the UE receives a DCI/DCI format” may refer to that “the UE detects the DCI/DCI format.”

In another example, the UE receives a DCI format and transmits a PUSCH based on time domain resources indicated by the DCI format. For example, a timing parameter K2 may be used to indicate a time interval between the PUSCH scheduled by the DCI format and the DCI format (e.g., a PDCCH carrying the DCI format), where K2 may be in units of slots. For example, FIG. 8B gives an example in which K2=1. In the example illustrated in FIG. 8B, the time interval between the PUSCH scheduled by the DCI format and the PDCCH carrying the DCI is one slot. K2 may also be used to indicate a time interval between a PDCCH for activating CG (configured grant) PUSCH(s) and the first activated CG PUSCH. In examples of the disclosure, unless otherwise specified, the PUSCH may be a dynamically scheduled PUSCH (e.g., scheduled by DCI) (e.g., may be referred to as DG (dynamic grant) PUSCH, in the example embodiments of the disclosure) and/or a PUSCH not scheduled by DCI (e.g., CG PUSCH).

In yet another example, the UE receives a PDSCH, and may transmit HARQ-ACK information for the PDSCH reception in a PUCCH in a second time unit. For example, a timing parameter (which may also be referred to as a timing value) K1 (e.g., the higher layer parameter dl-DataToUL-ACK) may be used to indicate a time interval between the PUCCH for transmission of the HARQ-ACK information for the PDSCH reception and the PDSCH, and K1 may be in units of second time units, such as slots or subslots. When K1 is in units of slots, the time interval is a slot offset value between the PUCCH for feeding back the HARQ-ACK information for the PDSCH reception and the PDSCH, and K1 may be called a slot timing value. For example, FIG. 8A gives an example in which K1=3. In the example illustrated in FIG. 8A, the time interval between the PUCCH for transmission of the HARQ-ACK information for the PDSCH reception and the PDSCH is 3 slots. It should be noted that in the example embodiments of the disclosure, the timing parameter K1 may be used interchangeably with a timing parameter K₁, the timing parameter K0 may be used interchangeably with a timing parameter K₀, and the timing parameter K2 may be used interchangeably with a timing parameter K₂.

The PDSCH may be a PDSCH scheduled by DCI and/or a SPS (semi-persistent scheduling) PDSCH. The UE periodically receives the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In the example embodiments of the disclosure, HARQ-ACK may be HARQ-ACK for a SPS PDSCH reception (e.g., HARQ-ACK not indicated by DCI) and/or HARQ-ACK indicated by a DCI format (e.g., HARQ-ACK for a PDSCH reception scheduled by a DCI format).

In yet another example, the UE receives DCI (e.g., DCI indicating SPS PDSCH release (deactivation)), and may transmit HARQ-ACK information for the DCI in a PUCCH in a second time unit. For example, the timing parameter K1 may be used to indicate a time interval between the PUCCH for transmission of the HARQ-ACK information for the DCI and the DCI, and K1 may be in units of second time units, such as slots or subslots. For example, FIG. 8C gives an example in which K1=3. In the example of FIG. 8C, the time interval between the PUCCH for transmission of the HARQ-ACK information for the DCI and the DCI is 3 slots. For example, the timing parameter K1 may be used to indicate a time interval between a PDCCH reception carrying DCI indicating SPS PDSCH release (deactivation) and the PUCCH feeding back HARQ-ACK for the PDCCH reception.

In some implementations, in operation S520, the UE may report (or signal/transmit) a UE capability or indicate the UE capability to the base station. For example, the UE reports (or signals/transmits) the UE capability to the base station by transmitting a PUSCH. In this case, the PUSCH transmitted by the UE includes UE capability information.

In some implementations, the base station may configure higher layer signaling for the UE based on a UE capability previously received from the UE (for example, in operation S510 in the previous downlink-uplink transmission process). For example, the base station configures higher layer signaling for the UE by transmitting a PDSCH. In this case, the PDSCH transmitted by the base station includes the higher-level signaling configured for the UE. It should be noted that higher layer signaling is higher layer signaling compared with physical layer signaling. For example, the higher layer signaling may include RRC signaling and/or MAC CE.

In some implementations, downlink channels (downlink resources) may include PDCCHs and/or PDSCHs. Uplink channels (uplink resources) may include PUCCHs and/or PUSCHs.

In some implementations, the UE may be configured with two levels of priorities for uplink transmission (for example, the UE is configured with the higher layer parameter PUCCH-ConfigurationList). For example, the UE may be configured/indicated to multiplex UCIs (e.g., HARQ-ACK) of different priorities via higher layer signaling (e.g., via higher layer parameter uci-MuxWithDiffPrio); otherwise (e.g., if the UE is not configured with the parameter for multiplexing UCIs with different priorities), the UE performs prioritization for PUCCHs and/or PUSCHs with different priorities. For example, the two levels of priorities may include a first priority and a second priority which are different from each other. In an example, the first priority may be higher than the second priority, that is, the first priority is the higher priority, and the second priority is the lower priority. In another example, the first priority may be lower than the second priority. However, embodiments of the disclosure are not limited to this, and for example, the UE may be configured with more than two levels of priorities. For the sake of convenience, in some example embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority. In some example embodiments of the disclosure, the terms “first priority”, “higher priority”, “greater priority index” and “priority index 1” may be used interchangeably. In the example embodiments of the disclosure, the terms “second priority”, “lower priority”, “smaller priority index” and “priority index 0” may be used interchangeably.

For example, the multiplexing of multiple PUCCHs and/or PUSCHs that overlap in time domain may include multiplexing UCI of the PUCCH in a PUCCH or PUSCH.

For example, the prioritization of two PUCCHs and/or PUSCHs that overlap in time domain by the UE may include that the UE transmits a PUCCH or PUSCH of a higher priority, and/or the UE does not transmit a PUCCH or PUSCH of a lower priority.

In some implementations, the UE may be configured with a subslot-based PUCCH transmission. For example, a subslot length parameter (which may also be referred to as a parameter with respect to a subslot length in the example embodiments of the disclosure) (e.g., the higher layer parameter subslotLengthForPUCCH) of each PUCCH configuration parameter of the first PUCCH configuration parameter and the second PUCCH configuration parameter may be 7 OFDM symbols or 6 OFDM symbols or 2 OFDM symbols. Subslot configuration length parameters in different PUCCH configuration parameters may be configured separately. If no subslot length parameter is configured in a PUCCH configuration parameter, the scheduling time unit of the PUCCH configuration parameter is one slot by default. If a subslot length parameter is configured in the PUCCH configuration parameter, the scheduling time unit of the PUCCH configuration parameter is L (L is the configured subslot configuration length) OFDM symbols.

The mechanism of a slot-based PUCCH transmission is basically the same as that of a subslot-based PUCCH transmission. In the disclosure, a slot may be used to represent a PUCCH occasion unit; for example, if the UE is configured with subslots, a slot which is a PUCCH occasion unit may be replaced with a subslot. For example, it may be specified by protocols that if the UE is configured with the subslot length parameter (e.g., the higher layer parameter subslotLengthForPUCCH), unless otherwise indicated, a number of symbols included in the slot of the PUCCH transmission is indicated by the subslot length parameter.

For example, if the UE is configured with the subslot length parameter, and a subslot n is the last uplink subslot overlapping with a PDSCH reception or PDCCH reception (e.g., SPS PDSCH release, and/or indicating SCell dormancy, and/or triggering a Type-3 HARQ-ACK codebook report and without scheduling PDSCH reception), then HARQ-ACK information for the PDSCH reception or PDCCH reception is transmitted in an uplink subslot n+k, where k is determined by the timing parameter K1 (the definition of the timing parameter K1 may refer to the previous description). For another example, if the UE is not configured with the subslot length parameter, and a slot n is the last uplink slot overlapping with a downlink slot where the PDSCH reception or PDCCH reception is located, then the HARQ-ACK information for the PDSCH reception or PDCCH reception is transmitted in an uplink slot n+k, where K is determined by the timing parameter K1.

In the example embodiments of the disclosure, unicast may refer to a manner in which a network communicates with a UE, and multicast (or groupcast) may refer to a manner in which a network communicates with multiple UEs. For example, a unicast PDSCH may be a PDSCH received by one UE, and scrambling of the PDSCH may be based on a Radio Network Temporary Identifier (RNTI) specific to the UE, e.g., Cell-RNTI (C-RNTI). A multicast PDSCH may be a PDSCH received by more than one UE simultaneously, and scrambling of the multicast PDSCH may be based on a UE-group common RNTI. For example, the UE-group common RNTI for scrambling the multicast PDSCH may include an RNTI (which may be referred to as Group RNTI (G-RNTI) in the example embodiments of the disclosure) for scrambling of a dynamically scheduled multicast transmission (e.g., PDSCH) or an RNTI (which may be referred to as group configured scheduling RNTI (G-CS-RNTI) in the example embodiments of the disclosure) for scrambling of a multicast SPS transmission (e.g., SPS PDSCH). UCI of the unicast PDSCH may include HARQ-ACK information, an SR, or CSI of the unicast PDSCH reception. UCI of the multicast PDSCH may include HARQ-ACK information of the multicast PDSCH reception. In the example embodiments of the disclosure, “multicast” may also be replaced by “broadcast”.

In some implementations, a HARQ-ACK codebook may include HARQ-ACK information (in the disclosure, it may also be called HARQ-ACK information bits) for one or more PDSCHs and/or DCI. If HARQ-ACK information for one or more PDSCH reception and/or DCI is multiplexed multiplexed in a second time unit (e.g., multiplexed in a same second time unit) for transmission, the UE may generate the HARQ-ACK codebook based on a predefined rule. For example, if a TB or CBG in a PDSCH reception is successfully decoded, HARQ-ACK information for the TB or CBG in the PDSCH reception is positive ACK. The positive ACK may be represented by a HARQ-ACK information bit of 1 in the HARQ-ACK codebook, for example. If a TB or CBG in a PDSCH is not successfully decoded, HARQ-ACK information for the TB or CBG in the PDSCH reception is negative ACK (NACK). The NACK may be represented by a HARQ-ACK information bit of 0 in the HARQ-ACK codebook, for example. For example, the UE may generate the HARQ-ACK codebook based on pseudo codes specified by protocols. In an example, if the UE receives a DCI format that indicates SPS PDSCH release (deactivation), the UE transmits HARQ-ACK information (ACK) for the DCI format. In another example, if the UE receives a DCI format that indicates secondary cell dormancy, the UE transmits HARQ-ACK information (ACK) for the DCI format. In yet another example, if the UE receives a DCI format that indicates to transmit HARQ-ACK information (e.g., a Type-3 HARQ-ACK codebook) of all HARQ-ACK processes of all configured serving cells, the UE transmits the HARQ-ACK information of all the HARQ-ACK processes of all the configured serving cells. In order to reduce a size of the Type-3 HARQ-ACK codebook, in an enhanced Type-3 HARQ-ACK codebook, the UE may transmit HARQ-ACK information of a specific HARQ-ACK process of a specific serving cell based on an indication of the DCI. In yet another example, if the UE receives a DCI format that schedules a PDSCH reception, the UE transmits HARQ-ACK information for the PDSCH reception. In yet another example, the UE receives a SPS PDSCH, and the UE transmits HARQ-ACK information for the SPS PDSCH reception. In yet another example, if the UE is configured by higher layer signaling to receive a SPS PDSCH, the UE transmits HARQ-ACK information for the SPS PDSCH reception. The reception of the SPS PDSCH configured by higher layer signaling may be cancelled by other signaling. In yet another example, if at least one uplink symbol (e.g., OFDM symbol) of the UE in a semi-static frame structure configured by higher layer signaling overlaps with a symbol of the SPS PDSCH reception, the UE does not receive the SPS PDSCH. In yet another example, if the UE is configured by higher layer signaling to receive a SPS PDSCH according to a predefined rule, the UE transmits HARQ-ACK information for the SPS PDSCH reception. It should be noted that, in the example embodiments of the disclosure, “A′ overlaps with ‘B’” may mean that ‘A’ at least partially overlaps with ‘B’. That is, “A′ overlaps with ‘B’” includes a case where ‘A’ completely overlaps with ‘B’. “‘A’ overlaps with ‘B’” may mean that ‘A’ overlaps with ‘B’ in time domain and/or ‘A’ overlaps with ‘B’ in frequency domain.

In some implementations, if HARQ-ACK information transmitted (or multiplexed) in a same second time unit does not include HARQ-ACK information for any DCI format, nor does it include HARQ-ACK information for a dynamically scheduled PDSCH reception (e.g., a PDSCH reception scheduled by a DCI format) and/or DCI, or the HARQ-ACK information transmitted (or multiplexed) in the same second time unit only includes HARQ-ACK information for one or more SPS PDSCH receptions, the UE may generate HARQ-ACK information (e.g., HARQ-ACK information only for SPS PDSCH receptions) according to a rule for generating a HARQ-ACK codebook for SPS PDSCH receptions. The UE may multiplex the HARQ-ACK information only for SPS PDSCH receptions in a specific PUCCH resource. For example, if the UE is configured with a PUCCH list parameter for SPS (e.g., SPS-PUCCH-AN-List), the UE multiplexes the HARQ-ACK information only for SPS PDSCH receptions in a PUCCH of a PUCCH list for SPS. For example, the UE determines a PUCCH resource in the PUCCH list for the SPS according to a number of HARQ-ACK information bits. If the UE is not configured with the PUCCH list parameter for SPS, the UE multiplexes the HARQ-ACK information only for SPS PDSCH receptions in a PUCCH resource specific to SPS HARQ-ACK (for example, the PUCCH resource is configured by the parameter nlPUCCH-AN).

In some implementations, if HARQ-ACK information transmitted (or multiplexed) in a same second time unit includes HARQ-ACK information for a DCI format, and/or a dynamically scheduled PDSCH (e.g., a PDSCH scheduled by a DCI format), the UE may generate HARQ-ACK information according to a rule for generating a HARQ-ACK codebook for a dynamically scheduled PDSCH and/or a DCI format. For example, the UE may determine to generate a semi-static HARQ-ACK codebook (e.g., Type-1 HARQ-ACK codebook) or a dynamic HARQ-ACK codebook (e.g., Type-2 HARQ-ACK codebook) according to a PDSCH HARQ-ACK codebook configuration parameter (e.g., the higher layer parameter pdsch-HARQ-ACK-Codebook). The dynamic HARQ-ACK codebook may also be an enhanced dynamic HARQ-ACK codebook (e.g., Type-2 HARQ-ACK codebook based on grouping and HARQ-ACK retransmission). The UE may multiplex the HARQ-ACK information in a PUCCH resource for HARQ-ACK associated with dynamically scheduling, which may be configured in a resource set list parameter (e.g., parameter resourceSetToAddModList). The UE determines a PUCCH resource set (e.g., parameter PUCCH-ResourceSet) in a resource set list according to a number of HARQ-ACK information bits, and the PUCCH resource may be determined as a PUCCH in the PUCCH resource set according to a PRI (PUCCH Resource Indicator) field indication in the last DCI format.

In some implementations, if HARQ-ACK information transmitted (multiplexed) in a same second time unit includes only HARQ-ACK information for SPS PDSCHs (e.g., PDSCH receptions not scheduled by DCI formats), the UE may generate the HARQ-ACK codebook according to a rule for generating a HARQ-ACK codebook for SPS PDSCH receptions (e.g., the pseudo code for a HARQ-ACK codebook for SPS PDSCH receptions).

The semi-static HARQ-ACK codebook (e.g., Type-1 HARQ-ACK codebook), may determine the size of the HARQ-ACK codebook and an order of HARQ-ACK information bits according to a semi-statically configured parameter (e.g., a parameter configured by higher layer signaling).

For a serving cell c, an active downlink BWP (bandwidth part), and an active uplink BWP, the UE determines a set of M_{A,c} occasions for candidate PDSCH receptions for which the UE can transmit corresponding HARQ-ACK information in a PUCCH in an uplink slot n_{U}.

M_{A,c} may be determined by at least one of:
a) a set of HARQ-ACK slot timing values K1 associated with the active uplink BWP on a primary cell or PUCCH-sScell (PUCCH switching SCell);
b) a set of row indexes of a time domain resource allocation (TDRA) table associated with the active downlink BWP;
C) 2^{μ}^{_{DL}}^{-μ}^{_{UL}}, where μ_{DL} is the configuration of a downlink subcarrier spacing (SCS) of the downlink active BWP, and PUL is the configuration of an uplink subcarrier spacing of the active uplink BWP.
d) a semi-static uplink and downlink frame structure configuration, such as the parameter tdd-UL-DL-ConfigurationCommon and the parameter tdd-UL-DL-ConfigurationDedicated.
e) a downlink slot offset parameter (e.g., the higher layer parameter

$${N}_{slot , offset , c}^{D L} )$$

for the serving cell c and its corresponding slot offset SCS (e.g., the higher layer parameter μ_{offset,DL,c}), and a slot offset parameter (e.g., the higher layer parameter

$${N}_{slot , offset}^{U L} )$$

for a primary cell and its corresponding slot offset SCS (e.g., the higher layer parameter μ_{offset,UL})

In the description of the example embodiments of the disclosure, the set of the parameter K1 is used to determine a candidate uplink slot, and then determine candidate downlink slots according to the candidate uplink slot. The candidate downlink slots satisfy at least one of the following conditions: (i) if the time unit of the PUCCH is a subslot, the end of at least one candidate PDSCH reception in the candidate downlink slots overlaps with the candidate uplink slot in time domain; or (ii) if the time unit of the PUCCH is a slot, the end of the candidate downlink slots overlaps with the candidate uplink slot in time domain. It should be noted that, in the description of the example embodiments of the disclosure, a starting symbol may be used interchangeably with a starting position, and an end symbol may be used interchangeably with an end position. In some implementations, the starting symbol may be replaced by the end symbol, and/or the end symbol may be replaced by the starting symbol.

A number of PDSCHs in a candidate downlink slot for which HARQ-ACK needs to be fed back is determined by a maximum value of a number of non-overlapping valid PDSCHs in the downlink slot (e.g., the valid PDSCHs may be PDSCHs that do not overlap with semi-statically configured uplink symbols). Time domain resources occupied by the PDSCHs may be determined by (i) a time domain resource allocation table configured by higher layer signaling (in the example embodiments of the disclosure, it may also be referred to as a table associated with time domain resource allocation) and (ii) a certain row in time domain resource allocation table dynamically indicated by a DCI. Each row in time domain resource allocation table may define information with respect to time domain resource allocation. For example, for the time domain resource allocation table, an indexed row defines a timing value (e.g., time unit (e.g., slot) offset (e.g., K0)) between a PDCCH and a PDSCH, and a start and length indicator (SLIV), or directly defines a starting symbol and allocation length. For example, for the first row of the time domain resource allocation table, a starting OFDM symbol is 0 and an OFDM symbol length is 4; for the second row of the time domain resource allocation table, the starting OFDM symbol is 4 and the OFDM symbol length is 4; and for the third row of the time domain resource allocation table, the starting OFDM symbol is 7 and the OFDM symbol length is 4. The DCI for scheduling the PDSCH may indicate any row in time domain resource allocation table. When all OFDM symbols in the downlink slot are downlink symbols, the maximum value of the number of non-overlapping valid PDSCHs in the downlink slot is 2. At this time, the Type-1 HARQ-ACK codebook may need to feed back HARQ-ACK information for two PDSCHs in the downlink slot on the serving cell.

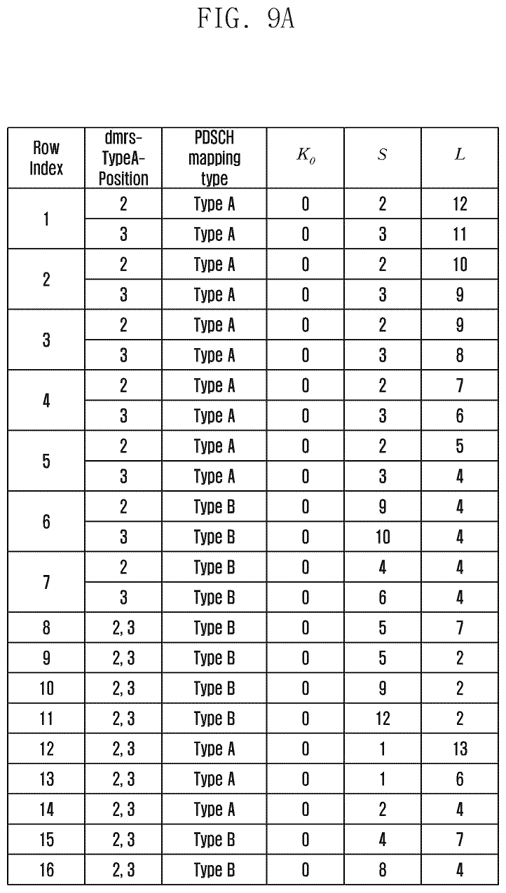

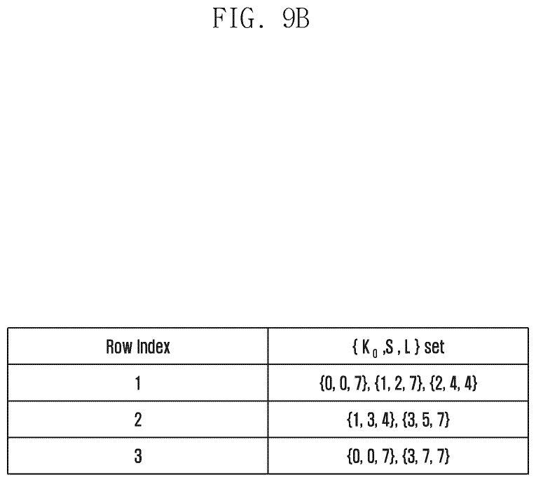

FIGS. 9A and 9B illustrate examples of time domain resource allocation tables (TDRAs). Specifically, FIG. 9A illustrates a time domain resource allocation table in which one PDSCH is scheduled in one row, and FIG. 9B illustrates a time domain resource allocation table in which multiple PDSCHs are scheduled in one row. Referring to FIG. 9A, each row corresponds to a set of {K0, mapping type, SLIV}, which includes a timing parameter K0 value, a mapping type, and an SLIV. Referring to FIG. 9B, unlike FIG. 9A, each row corresponds to multiple sets of {K0, mapping type, SLIV}.

In some implementations, the dynamic HARQ-ACK codebook (e.g., Type-2 HARQ-ACK codebook) and/or the enhanced dynamic HARQ-ACK codebook (e.g., Type-2 HARQ-ACK based on grouping and HARQ-ACK retransmission) may determine a size and an order of the HARQ-ACK codebook according to an assignment indicator. For example, the assignment indicator may be a DAI (Downlink Assignment Indicator). In the following embodiments, the assignment indicator as the DAI is taken as an example for illustration. However, the example embodiments of the disclosure are not limited thereto, and any other suitable assignment indicator may be adopted. It should be noted that the method for dynamic HARQ-ACK codebook in the disclosure may also be used for enhanced dynamic HARQ-ACK codebook.

In some implementations, the DAI field includes at least one of a first DAI and a second DAI.

In some examples, the first DAI may be a C-DAI (Counter-DAI). The first DAI may indicate an accumulative number of at least one of DCI scheduling PDSCH(s), DCI format(s) indicating SPS PDSCH release (deactivation), or DCI indicating secondary cell dormancy. For example, the accumulative number may be an accumulative number up to the current serving cell and/or the current time unit. For example, the C-DAI may also indicate: an accumulative number of {serving cell, time unit} pair(s) scheduled by PDCCH(s) up to the current time unit within a time window (which may also include a number of PDCCHs (e.g., PDCCHs indicating SPS release and/or PDCCHs indicating secondary cell dormancy)); or an accumulative number of PDCCH(s) up to the current time unit; or an accumulative number of PDSCH transmission(s) up to the current time unit; or an accumulative number of {serving cell, time unit} pair(s) in which PDSCH transmission(s) related to PDCCH(s) (e.g., scheduled by the PDCCH(s)) and/or PDCCH(s) (e.g., PDCCH indicating SPS release and/or PDCCH indicating secondary cell dormancy) is present, up to the current serving cell and/or the current time unit; or an accumulative number of PDSCH(s) with corresponding PDCCH(s) and/or PDCCHs (e.g., PDCCHs indicating SPS release and/or PDCCHs indicating secondary cell dormancy) already scheduled by a base station up to the current serving cell and/or the current time unit; or an accumulative number of PDSCHs (the PDSCHs are PDSCHs with corresponding PDCCHs) already scheduled by the base station up to the current serving cell and/or the current time unit; or an accumulative number of time units with PDSCH transmissions (the PDSCHs are PDSCHs with corresponding PDCCHs) already scheduled by the base station up to the current serving cell and/or the current time unit. The order of each bit in the HARQ-ACK codebook corresponding to at least one of PDSCH reception(s), DCI format(s) indicating SPS PDSCH release (deactivation), or DCI indicating secondary cell dormancy may be determined by the time when the first DAI is received and the information of the first DAI. The first DAI may be included in a downlink DCI format.

In some examples, the second DAI may be a T-DAI (Total-DAI). The second DAI may indicate a total number of at least one of all PDSCH receptions, DCI indicating SPS PDSCH release (deactivation), or DCI format(s) indicating secondary cell dormancy. For example, the total number may be a total number of all serving cells up to the current time unit. For example, the T-DAI may refer to: a total number of {serving cell, time unit} pairs scheduled by PDCCH(s) up to the current time unit within a time window (which may also include a number of PDCCHs for indicating SPS release); or a total number of PDSCH transmissions up to the current time unit; or a total number of {serving cell, time unit} pairs in which PDSCH transmission(s) related to PDCCH(s) (e.g., scheduled by the PDCCH) and/or PDCCH(s) (e.g., a PDCCH indicating SPS release and/or a PDCCH indicating secondary cell dormancy) is present, up to the current serving cell and/or the current time unit; or a total number of PDSCHs with corresponding PDCCHs and/or PDCCHs (e.g., PDCCHs indicating SPS release and/or PDCCHs indicating secondary cell dormancy) already scheduled by a base station up to the current serving cell and/or the current time unit; or a total number of PDSCHs (the PDSCHs are PDSCHs with corresponding PDCCHs) already scheduled by the base station up to the current serving cell and/or the current time unit; or a total number of time units with PDSCH transmissions (e.g., the PDSCHs are PDSCHs with corresponding PDCCHs) already scheduled by the base station up to the current serving cell and/or the current time unit. The second DAI may be included in a downlink DCI format and/or an uplink DCI format. The second DAI included in the uplink DCI format is also called UL DAI or UL T-DAI.

In the following examples, the first DAI as the C-DAI and the second DAI as the T-DAI are taken as an example (but not limited thereto) for illustration.

Tables 1 and 2 show a correspondence between the DAI field and V_{T-DAI,m} or V_{C-DAI,c,m} or

$${V}_{T - DAI}^{U L} .$$

Numbers of bits of the C-DAI and T-DAI are limited. For example, in case that a C-DAI or T-DAI in a DCI format is represented with 2 bits, the value of the C-DAI or T-DAI in the DCI may be determined by equations in Table 1, V_{T-DAI,m} or

$${V}_{T - DAI}^{UL}$$

is the value of the T-DAI in the DCI received in a PDCCH Monitoring Occasion (MO)m, and V_{C-DAI,c,m} is the value of the C-DAI in the DCI for a serving cell c received in the PDCCH monitoring occasion m. Both V_{T-DAI,m} and V_{C-DAI,c,m} are related to a number of bits of the DAI field in the DCI. MSB is the most significant bit and LSB is the least significant bit.

TABLE 1

| MSB, LSB of DAI Field | $\begin{matrix}{V}_{T - DAI , m} or {V}_{C - DAI , c , m} \\ or {V}_{T - DAL}^{UL}\end{matrix}$ | Y |
|---|---|---|
| 0, 0 | 1 | (Y − 1) mod 4 + 1 = 1 |
| 0, 1 | 2 | (Y − 1) mod 4 + 1 = 2 |
| 1, 0 | 3 | (Y − 1) mod 4 + 1 = 3 |
| 1, 1 | 4 | (Y − 1) mod 4 + 1 = 4 |

For example, when the C-DAI or T-DAI is 1, 5 or 9, as shown in Table 1, all of the DAI field are indicated with “00”, and the value of V_{T-DAI,m} or V_{C-DAI,c,m} is represented as “1” by the equation in Table 1. Y may represent the value of the DAI corresponding to the number of DCIs actually transmitted by the base station (the value of the DAI before conversion by the equation in the table).

For example, in case that the C-DAI or T-DAI in the DCI is 1 bit, values greater than 2 may be represented by equations in Table 2.

TABLE 2

| | V_{T-DAI, m} or | |
|---|---|---|
| DAI Field | V_{C-DAI, c, m} | Y |
| 0 | 1 | (Y − 1) mod 2 + 1 = 1 |
| 1 | 2 | (Y − 1) mod 2 + 1 = 2 |

In some implementations, the UE may generate a HARQ-ACK codebook in a PUCCH according to pseudo-code 1.

```
  [Pseudo-code 1]
  $Denote {N}_{C - DAI}^{DL} the number of bits for the C - DAI and set {T}_{D} = {2}^{{N}_{C - DAI}^{D L}} .$
  $Denote {V}_{C - DAI , c , m}^{D L} the value of the C - DA1 in a DCI format on serving cell c in PDCCH$
    monitoring occasion m.
  $Denote {V}_{T - DAI , m}^{D L} the value of the T - DAI in a DCI format in PDCCH monitoring occasion$
m.
  Set m = 0 - PDCCH monitoring occasion index
  Set j = 0
  Set Vₜₑₘₚ = 0
  Set Vₜₑₘₚ₂ = 0
  Set Vₛ = ∅
  $Set {N}_{cells}^{D L} to the number of serving cells configured by higher layers for the UE$
  Set M to the number of PDCCH monitoring occasion(s)
  while m < M
    Set c = 0 - serving cell index
    $while c < {N}_{cells}^{D L}$
      if PDCCH monitoring occasion m is before an active DL BWP change on serving
      cell c or an active UL BWP change on the PCell, and/or a DL BWP change is not
      triggered in PDCCH monitoring occasion m
        c = c + 1;
      else
        if there is a DCI format indicating associated HARQ-ACK information on
        serving cell c in PDCCH monitoring occasion m
          $if {V}_{C - DAI , c , m}^{D L} \leq {V}_{temp}$
            j = j + 1
          end if
          ${V}_{temp} = {V}_{C - DAI , c , m}^{D L}$
          ${V}_{t emp 2} = {V}_{C - DAI , c , m}^{D L}$
        else
          ${V}_{temp 2} = {V}_{T - DAI , m}^{D L}$
        end if
        if UE is not configured with harq-ACK-SpatialBundlingPUCCH and for DL
        BWP(s) of serving cell c, the UE is configured with reception of two transport
        blocks for at least one DL BWP of at least one serving cell (e.g., by the 3GPP
        parameter maxNrofCodeWordsScheduledByDCI),
          ${\tilde{o}}_{2 \cdot {T}_{D} \cdot j + 2 ( {V}_{C - DAI , c , m}^{D L} - 1 )}^{A C K} = HARQ - ACK information bit corresponding to the$
            first transport block of this cell
          ${\tilde{o}}_{2 \cdot {T}_{D} \cdot j + 2 ( {V}_{C - DAI , c , m}^{D L} - 1 ) + 1}^{A C K} = HARQ - ACK information bit corresponding to$
            the second transport block of this cell
          ${V}_{s} = {V}_{s} ⋃ \{ 2 \cdot {T}_{D} \cdot j + 2 ( {y}_{C - DAI , c , m}^{D L} - 1 ) , 2 \cdot {T}_{D} \cdot j + 2 ( {V}_{C - DAI , c , m}^{D L} - 1 ) + 1 \}$
        elseif UE is configured with harq-ACK-SpatialBundlingPUCCH and for DL
        BWP(s) of serving cell c, the UE is configured with reception of two transport
        blocks for at least one DL BWP of at least one serving cell (e.g., by the 3GPP
        parameter maxNrofCodeWordsScheduledByDCI), and m is a monitoring
        occasion in which a DCI format scheduling two transport blocks can be received,
          ${\tilde{o}}_{{T}_{D} \cdot j + {V}_{C - DAI , c , m}^{D L} - 1}^{A C K} = binary AND operation of the HARQ - ACK information$
            bits corresponding to the first and second transport blocks of serving cell c
          ${V}_{s} = {V}_{s} ⋃ \{ {T}_{D} \cdot j + {V}_{C - DAI , c , m}^{D L} - 1 \}$
        else
          ${\tilde{o}}_{{T}_{D} \cdot j + {V}_{C - DAI , c , m}^{D L} - 1}^{ACK} = HARQ - ACK information bit of this cell$
          ${V}_{s} = {V}_{s} ⋃ \{ {T}_{D} \cdot j + {V}_{C - DAI , c , m}^{D L} - 1 \}$
        end if
      end if
      c = c + 1
    end if
  end while
  m = m + 1
end while
  ${V}_{temp} = ( j mod ( \frac{4}{{T}_{D}} ) ) \times ( \frac{4}{{T}_{D}} ) + {V}_{temp}$
$if UE does not set {V}_{temp 2} = {V}_{T - DAI}^{U L} and {T}_{D} = 2$
  Vₜₑₘₚ₂ = Vₜₑₘₚ
end if
$j = ⌊ \frac{j \times {T}_{D}}{4} ⌋$
if Vₜₑₘₚ₂ < Vₜₑₘₚ
  j = j + 1
end if
if UE is not configured with harq-ACK-SpatialBundlingPUCCH and for DL BWP(s) of
serving cell c, the UE is configured with reception of two transport blocks for at least one
DL BWP of at least one serving cell (e.g., by the 3GPP parameter
maxNrofCodeWordsScheduledByDCI),
  O^{ACK} = 2 · (4 · j + Vₜₑₘₚ₂)
else
  O^{ACK} = 4 · j + Vₜₑₘₚ₂
end if
${\tilde{o}}_{i}^{A C K} = NACK , for any i ∈ \{ 0 , 1 , … , {O}^{A C K} - 1 \} ∖ {V}_{s}$
```

In some implementations, for a HARQ-ACK codebook in a PUSCH, the UE may set

$${V}_{t emp 2} = {V}_{T - DAI}^{UL}$$

after completing the c and m loops of generating the HARQ-ACK codebook in pseudo-code 1, where

$${V}_{T - DAI}^{UL}$$

is UL DAI, the value of which may be determined according to Table 1.

In some implementations, whether to feed back HARQ-ACK information may be configured by higher layer parameters or dynamically indicated by a DCI. The mode of feeding back (or reporting) the HARQ-ACK information (HARQ-ACK feedback mode or HARQ-ACK reporting mode) may also be at least one of the following modes.
HARQ-ACK feedback mode 1: transmitting ACK or NACK (ACK/NACK). For example, for a PDSCH reception, if the UE decodes a corresponding transport block (TB) correctly, the UE transmits ACK; and/or, if the UE does not decode the corresponding transport block correctly, the UE transmits NACK. For example, a HARQ-ACK information bit of the HARQ-ACK information provided according to the HARQ-ACK feedback mode 1 is an ACK value or a NACK value.
HARQ-ACK feedback mode 2: transmitting NACK only (NACK-only). For example, for a PDSCH reception, if the UE decodes the corresponding transport block correctly, the UE does not transmit the HARQ-ACK information; and/or, if the UE does not decode the corresponding transport block correctly, the UE transmits NACK. For example, at least one HARQ-ACK information bit of the HARQ-ACK information provided according to the HARQ-ACK feedback mode 2 is a NACK value. For example, for the HARQ-ACK feedback mode 2, the UE does not transmit a PUCCH that would include only HARQ-ACK information with ACK values.

In some implementations, a PUSCH conflicting/colliding with other physical channel(s) may be at least one of:
a PUSCH overlapping in time domain with PUCCH(s) and/or PDSCH(s) and/or PDCCH(s) on a same serving cell;
in case that simultaneous transmission for PUSCH is not configured, a PUSCH overlapping in time domain with other PUSCH(s) on a same serving cell;
in case that the simultaneous transmission for PUSCH is configured, a PUSCH overlapping in time domain with another PUSCH, on a same serving cell, with a same value of a CORESET pool index parameter (e.g., coresetPoolIndex); or
a PUSCH overlapping in time domain with a PUCCH. For example, a PUSCH overlaps in time domain with a PUCCH on a different serving cell, and/or the serving cell does not support simultaneous transmission of the PUSCH and the PUCCH.

In some implementations, a PDSCH conflicting/colliding with other physical channel(s) may be at least one of:
a PDSCH overlapping in time domain with other PUSCH(s) and/or PUCCH(s) and/or PDSCH(s) on a same serving cell;
in case that simultaneous reception for PDSCH is not configured (for example, the UE is not configured with different values of the CORESET pool index parameter (e.g., coresetPoolIndex)), a PDSCH overlapping in time domain with other PUSCH(s) on a same serving cell;
in case that simultaneous transmission for PDSCH is configured (for example, the UE is configured with a PDCCH configuration parameter (e.g., PDCCH-Config) including a CORESET parameter (e.g., ControlResourceSet) with different values of the CORESET pool index parameter (e.g., coresetPoolIndex)), a PDSCH overlapping in time domain with another PDSCH on a same serving cell with a same value of the CORESET pool index parameter (e.g., coresetPoolIndex); or
a PDSCH overlapping in both time domain and frequency domain with a PDCCH on a same serving cell.

In some implementations, a PUCCH conflicting/colliding with other physical channel(s) may be at least one of:
a PUCCH overlapping in time domain with other PUCCH(s) and/or PUSCH(s); or
a PUCCH overlapping in time domain with other PDSCH(s) on a same serving cell.

In some implementations, a PDCCH conflicting/colliding with other physical channel(s) may be at least one of:
a PDCCH overlapping in time domain with other PUSCH(s) and/or PUCCH(s) on a same serving cell; or
a PDCCH overlapping in both time domain and frequency domain with other PDSCH(s) on a same serving cell n.

In the description of the example embodiments of the disclosure, “a set/group of overlapping channels” may be understood as that each channel of the set/group of overlapping channels overlaps (or collides) with at least one of channels in the set/group except this channel. The channels may include one or more PUCCHs and/or one or more PUSCHs. For example, “a set/group of overlapping channels” may include “a set/group of overlapping PUCCHs and/or PUSCHs”. As a specific example, when a first PUCCH overlaps with at least one of a second PUCCH and a third PUCCH, the second PUCCH overlaps with at least one of the first PUCCH and the third PUCCH, and the third PUCCH overlaps with at least one of the first PUCCH and the second PUCCH, the first PUCCH, the second PUCCH and the third PUCCH constitute a set/group of overlapping channels (PUCCHs). For example, the first PUCCH overlaps with the second PUCCH and the third PUCCH, and the second PUCCH and the third PUCCH do not overlap.

It should be noted that, in the description of the example embodiments of the disclosure, “resolving overlapping channels” may be understood as resolving the collision of overlapping channels. For example, when a PUCCH overlaps with a PUSCH, resolving the overlapping or collision may include multiplexing UCI of the PUCCH in the PUSCH, or may include transmitting the PUCCH or PUSCH with a higher priority. For another example, when a PUCCH overlaps with one or another PUCCH, resolving the overlapping or collision may include multiplexing UCI in a PUCCH, or may include transmitting the PUCCH with a higher priority. For yet another example, when two PUSCHs on a same serving cell overlap, resolving the overlapping or collision may include transmitting a PUSCH with a higher priority of the two PUSCHs.

It should be noted that, unless the context clearly indicates otherwise, all or one or more of the methods, steps or operations described in the example embodiments of the disclosure may be specified by protocols and/or configured by higher layer signaling and/or indicated by dynamic signaling. The dynamic signaling may be a PDCCH and/or DCI and/or a DCI format. For example, a SPS PDSCH and/or CG PUSCH may be dynamically indicated in a corresponding activated DCI/DCI format/PDCCH. All or one or more of the described methods, steps and operations may be optional. For example, if a certain parameter (e.g., parameter X) is configured, the UE performs a certain approach (e.g., approach A), otherwise (if the parameter, e.g., parameter X, is not configured), the UE performs another approach (e.g., approach B). Unless otherwise specified, the parameters in the example embodiments of the disclosure may be higher layer parameters. For example, the higher layer parameters may be parameters configured or indicated by higher layer signaling (e.g., RRC signaling).

It should be noted that, a PCell (Primary Cell) or PSCell (Primary Secondary Cell) in the example embodiments of the disclosure may be used interchangeably with a cell having a PUCCH. A serving cell may be used interchangeably with a cell.

It should be noted that, methods for downlink in the example embodiments of the disclosure may also be applicable to uplink, and methods for uplink may also be applicable to downlink. For example, a PDSCH may be replaced with a PUSCH, a SPS PDSCH may be replaced with a CG PUSCH, and downlink symbols may be replaced with uplink symbols, so that methods for downlink may be applicable to uplink.

It should be noted that, methods applicable to scheduling multiple PDSCHs/PUSCHs in the example embodiments of the disclosure may also be applicable to a PDSCH/PUSCH transmission with repetitions. For example, a PDSCH/PUSCH of multiple PDSCHs/PUSCHs may be replaced by a repetition of multiple repetitions of the PDSCH/PUSCH transmission.

It should be noted that in methods of the disclosure, “configured with and/or indicated a transmission with repetitions” may be understood that a number of the repetitions of the transmission is greater than 1. For example, “configured with and/or indicated a PUCCH transmission with repetitions” may be understood that “the PUCCH transmission is repeated on more than one slot/subslot”. “Not configured with and/or indicated a transmission with repetitions” may be understood that a number of the repetitions of the transmission is equal to 1. For example, “not configured with and/or indicated a PUCCH transmission with repetitions” may be understood that “a number of the repetitions of the PUCCH transmission is equal to 1”. For example, the UE may be configured with a parameter

$${N}_{PUCCH}^{repeat}$$

related to a number of repetitions of a PUCCH transmission; when the parameter

$${N}_{PUCCH}^{repeat}$$

is greater than 1, it may mean that the UE is configured with a PUCCH transmission with repetitions, and the UE may repeat the PUCCH transmission on

$${N}_{PUCCH}^{repeat}$$

time units (e.g., slots); when the parameter is equal to 1, it may mean that the UE is not configured with a PUCCH transmission with repetitions. For example, the PUCCH transmission with repetitions may include only one type of UCI. If the PUCCH is configured with repetitions, in the example embodiments of the disclosure, a repetition of the multiple repetitions of the PUCCH may be used as a PUCCH (or a PUCCH resource), or all of the repetitions of the PUCCH may be used as a PUCCH (or a PUCCH resource), or a specific repetition of the multiple repetitions of the PUCCH may be used as a PUCCH (or a PUCCH resource).

It should be noted that, in methods of the disclosure, a PDCCH and/or DCI and/or a DCI format schedules multiple PDSCHs/PUSCHs, which may be multiple PDSCHs/PUSCHs on a same serving cell and/or multiple PDSCHs/PUSCHs on different serving cells.

It should be noted that, multiple manners/methods described in the disclosure may be combined in any order. In a combination, a manner/method may be performed one or more times.

It should be noted that, steps/operations of manners/methods of the disclosure may be implemented in any order.

It should be noted that, in the example embodiments of the disclosure, “canceling a transmission” may mean canceling the transmission of the entire uplink channel and/or cancelling the transmission of a part of the uplink channel.

It should be noted that, in the example embodiments of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in the example embodiments of the disclosure, a PUCCH/PUSCH with/including/with A may be understood as a PUCCH/PUSCH only carrying/including/with A, and may also be understood as a PUCCH/PUSCH with/including/with at least A.

It should be noted that, in the example embodiments of the disclosure, “slot” may be replaced by “subslot” or “time unit”.

It should be noted that, in the example embodiments of the disclosure, “performing a predefined method (or step) if a predefined condition is satisfied” and “not performing the predefined method (or step) if the predefined condition is not satisfied” may be used interchangeably. “Not performing a predefined method (or step) if a predefined condition is satisfied” and “performing the predefined method (or step) if the predefined condition is not satisfied” may be used interchangeably.

It should be noted that in the description of the example embodiments of the disclosure, “configured with a parameter (or information)”, “provided with a parameter (or information)” and “received with a parameter (or information)” may be used interchangeably. “Configured with one or more parameters” may refer to being configured with a parameter list in an IE (information element), where the parameter list includes the one or more parameters. “Configured with one or more parameters” may also refer to being configured with the one or more parameters in multiple IEs, respectively.

It should be noted that in the description of the example embodiment of the disclosure, “PUCCH with HARQ-ACK information” and “PUCCH including HARQ-ACK information” may be used interchangeably.

It should be noted that in the description of the example embodiments of this disclosure, “HARQ-ACK”, “HARQ-ACK feedback”, “HARQ-ACK information”, “HARQ-ACK information bit(s)” and “HARQ-ACK codebook” may be used interchangeably.

It should be noted that in the description of the example embodiment of the disclosure, “determining HARQ-ACK information bit(s)” and “generating HARQ-ACK information bit(s)” may be used interchangeably.

It should be noted that in the description of the example embodiments of this disclosure, “uplink” and “downlink” may be used interchangeably, “channel”, “channel transmission”, “physical channel” and “physical channel transmission” may be used interchangeably, “physical channel” and “physical channel resource” may be used interchangeably, and “PUCCH” and “PUCCH resource” may be used interchangeably.

It should be noted that in the description of the example embodiments of the disclosure, “the starting time of a resource (or channel)” and “the first symbol of the resource (or channel)” and “the starting time of the first symbol of the resource (or channel)” may be used interchangeably.

It should be noted that in the description of the example embodiments of the disclosure, “the end time of a resource (or channel)” and “the last symbol of a resource (or channel)” and “the end time of the last symbol of a resource (or channel)” may be used interchangeably.

It should be noted that in the description of the example embodiment of the disclosure, the overlapping of two or more physical channels may refer to that the two or more physical channels overlap in time domain and/or frequency domain.

It should be noted that in the description of the example embodiments of the disclosure, the method applicable to RRC parameters may also be applicable to MAC CEs, and vice versa.

It should be noted that in the description of the example embodiments of the disclosure, “first and second” and “two” may be used interchangeably. For example, “first channel and second channel” may refer to two channels. In the description of example embodiments of the disclosure, “first and second” may also refer to two or more. For example, “first channel and second channel” may also refer to two or more channels.

It should be noted that in the description of the example embodiments of the disclosure, the behavior of the UE (or the base station) and the condition corresponding to the behavior the UE (or the base station) may be used interchangeably. For example, “the UE receives (or is configured) first information (or parameter)” and “if the UE is configured with the first information (or parameter)” may be used interchangeably.

It should be noted that in the description of the example embodiments of the disclosure, receiving information carried by a DCI format may be understood as detecting a DCI format that carries the information.

It should be noted that in the description of the example embodiments of the disclosure, the terms “index”, “identification”, “identifier” and “number” may be used interchangeably.

In some cases, in order to reduce the energy/power consumption of the base station, the base station may operate in an energy/power saving mode (for example, cell off mode; for another example, non-active mode) or dormant mode or predetermined mode (in the example embodiments of the disclosure, which may be called “mode related to network energy saving”). For example, in the energy saving mode or dormant mode or predetermined mode, the base station does not transmit a specific downlink signal and/or the base station does not receive a specific uplink signal.

In some implementations, it may be specified by protocols and/or configured by higher layer signaling and/or indicated by dynamic signaling an operating mode of the base station (for example, whether the operating mode is the energy saving mode; for another example, a discontinuous reception (DRX)/discontinuous transmission (DTX) mode of a cell (e.g., serving cell)), and/or an operation mode (or state) of the UE, and/or parameters related to cell discontinuous reception and/or cell discontinuous transmission. The above descriptions about the energy saving mode may be used interchangeably. For example, there may be the following two modes, Mode 1 and Mode 2.

Mode 1 (in the example embodiments of the disclosure, which may also be called “first mode”): For example, Mode 1 may be a non-energy saving mode (also called a normal mode) or an active mode. In Mode 1, normal communications (uplink and/or downlink transmissions) may be performed between the base station and the UE. For example, when in Mode 1, the base station may transmit a downlink channel and/or the base station may receive an uplink channel. Or, when in Mode 1, the UE may receive a downlink channel transmitted by the base station and/or the UE may transmit an uplink channel. It should be noted that Mode 1 may be an existing mode. Being in Mode 1 may be understood as being in a period (or state) of Mode 1, for example, being in an active period (or state).
Mode 2 (in the example embodiments of the disclosure, which may also be called “second mode”): For example, Mode 2 may be an energy saving mode or a dormant mode or a non-active mode. In Mode 2, the base station may not perform some or all downlink transmissions or uplink receptions. For example, when in Mode 2, the base station may not transmit some or all downlink channels and/or the base station may not receive some or all uplink channels, and correspondingly, the UE may not receive some or all downlink channels and/or the UE may not transmit some or all uplink channels. Or, when in Mode 2, the UE does not expect the base station to transmit some or all downlink channels and/or the base station to receive some or all uplink channels. Being in Mode 2 may be understood as being in a time (or state) of Mode 2, for example, being in a non-active period (or state). For another example, being in Mode 2 may be understood as being in a DRX and/or DTX opportunity.

In some implementations, the UE may be configured and/or indicate a mode or state that is suitable for downlink receptions and/or uplink transmissions of the UE. For example, a mode or state may be configured and/or indicated for the UE in a serving cell, which is suitable for downlink receptions and uplink transmissions of the UE in the serving cell. The behavior (e.g., downlink receiving method and/or uplink transmitting method) of the UE in the mode may also be specified by the protocols.

In some implementations, a mode or state may be configured and/or indicated separately for downlink receptions and uplink transmissions of the UE, for example, a downlink mode or state corresponding to downlink receptions and an uplink mode or state corresponding to uplink transmissions; for example, a mode or state may be configured and/or indicated separately for downlink receptions and uplink transmissions of the UE for a serving cell in a TDD band. Alternatively, a mode or state may be configured and/or indicated for downlink receptions and uplink transmissions of the UE. For example, a mode or state may be configured and/or indicated for downlink receptions and uplink transmissions of the UE for a serving cell in a FDD band. The behavior (e.g., downlink receiving method) of the UE in a downlink mode or state and/or the behavior (e.g., uplink transmitting method) of the UE in an uplink mode may also be specified by protocols. A UE capability about whether the UE supports a corresponding energy saving mode may also be reported by the UE separately for downlink receptions and uplink transmissions.

It should be noted that the example embodiments of the disclosure may be applicable to one serving cell as well as multiple serving cells.

It should be noted that configuring and/or indicating a mode or state in the example embodiments of the disclosure may be understood as configuring one or more parameters related to network energy saving and/or cell DRX and/or DTX. The one or more parameters related to network energy saving and/or cell DRX and/or DTX may include at least one of a cycle, a starting slot (or offset), an activity duration (a period of activity), or timers (e.g., one or more timers). The cell DRX and/or DTX may be understood as cell-specific DRX and/or DTX. The cell DRX and/or DTX may be DRX and/or DTX common to UEs in a cell. The term “cell DRX and/or DTX” may refer to DRX and/or DTX of a cell or a corresponding base station, and/or DRX and/or DTX of a terminal. It should be noted that the term “cell DRX and/or DTX” used in the disclosure is only an example, and any suitable term may be used to represent transmissions and/or receptions related to energy saving and/or DRX and/or DTX of a base station and/or a terminal.

In some cases, the UE may be configured with one or more parameters related to network energy saving and/or cell DRX and/or DTX (for example, parameters related to Mode 1 and/or Mode 2 described above, or cell DRX and/or DTX parameters). In some examples, when a UE (e.g., a MAC entity) is configured with parameters related to Mode 1 and/or Mode 2, the UE may have an active period corresponding to Mode 1 and/or a non-active period corresponding to Mode 2. In some examples, when the UE is configured with DRX and/or DTX parameters, the UE may have an active period and/or a non-active period. For example, for the DRX parameters, the active period may be a duration that the UE receives downlink channels and/or signals (e.g., monitors PDCCH); the non-active period may be a duration that the UE does not receive some or all downlink channels and/or signals. For the DTX parameters, the active period may be a duration that the UE transmits uplink channels and/or signals; the non-active period may be a duration that the UE does not transmit some or all uplink channels and/or signals, that is, the non-active period may be a discontinuous reception and/or cell discontinuous transmission opportunity. The operation related to network energy saving may be periodic. An energy saving cycle may include an active period and/or a non-active period following the active period. For example, when the UE is configured with the DRX parameters, the DRX cycle may include an active period and/or a non-active period following the active period. In some embodiments of the disclosure, the configuration of the UE in a mode related to network energy saving (Mode 1 and/or Mode 2) and/or cell DRX and/or DTX may include that the UE is configured to have a corresponding mode or operate in a corresponding mode (UE power saving), and/or is informed that the base station or a cell has a corresponding mode and/or that the base station operates in a corresponding mode (network (base station) energy saving).

In some implementations, at least one of the following Methods MN1 to MN5 may be adopted to receive and/or transmit data or control information.

### Method MN1

In Method MN1, the UE receives data and/or first information. The first information may indicate information related to cell discontinuous reception and/or cell discontinuous transmission. The first information may be carried by a PDCCH or PDSCH. For example, the PDSCH may carry a higher layer parameter, such as one or more parameters related to network energy saving and/or cell discontinuous reception and/or cell discontinuous transmission, including one or more of a cycle, a starting slot (or offset), an activity duration or a timer. The PDSCH may also carry a MAC CE. The PDCCH may carry DCI (e.g., DCI format), such as DCI indicating the information related to cell discontinuous reception and/or cell discontinuous transmission. The information related to cell discontinuous reception and/or cell discontinuous transmission may be used for at least one of the following or include an indication for at least one of the following:
indicating activation/deactivation (or release) of cell discontinuous reception and/or cell discontinuous transmission;
indicating modification (or update) of parameter(s) related to cell discontinuous reception and/or cell discontinuous transmission;
indicating whether to start (or skip, e.g., not start) activity timers (e.g., cell-drx-onDurationTimer and/or cell-dtx-onDurationTimer) of next one or more cycles of cell discontinuous reception and/or cell discontinuous transmission (next one or more cell DRX and/or cell DTX cycles). The activity timer may indicate a duration or time interval at the beginning of a cycle. The duration or time interval is the active period.

In some implementations, it may be determined whether the first information or the information related to cell discontinuous reception and/or cell discontinuous transmission is applied. For example, the application of the first information or the information related to cell discontinuous reception and/or cell discontinuous transmission may be or refer to at least one of the following:
activation/deactivation (or release) of cell discontinuous reception and/or cell discontinuous transmission, when the first information or the information related to cell discontinuous reception and/or cell discontinuous transmission indicates activation/deactivation (or release) of cell discontinuous reception and/or cell discontinuous transmission;
modification (or update) of the parameter(s) related to cell discontinuous reception and/or cell discontinuous transmission, when the first information or the information related to cell discontinuous reception and/or cell discontinuous transmission indicates modification (or update) of the parameter(s) related to cell discontinuous reception and/or cell discontinuous transmission;
starting (or skipping) of activity timers (for example, cell-drx-onDurationTimer and/or cell-dtx-onDurationTimer) of next one or more cycles of cell discontinuous reception and/or cell discontinuous transmission, when the first information or the information related to cell discontinuous reception and/or cell discontinuous transmission indicates to start or skip the activity timers of the next one or more cycles of cell discontinuous reception and/or cell discontinuous transmission.

The UE may generate corresponding HARQ-ACK information for data and/or the first information. For example, the HARQ-ACK information may be a HARQ-ACK codebook. For example, if the UE successfully decodes a TB or CBG, the UE generates a 1-bit ACK for the TB or CBG; otherwise, if the UE does not successfully decode the TB or CBG, the UE generates a 1-bit NACK for the TB or CBG. For another example, if the UE detects a DCI format indicating the first information, the UE generates a 1-bit ACK for the DCI format.

The UE may transmit a PUCCH or PUSCH transmission carrying the HARQ-ACK information. The HARQ-ACK information may include ACK information (or ACK bit) corresponding to the first information. The first information may be applied after the UE transmits the PUCCH or PUSCH transmission. For example, when the first information indicates activation/deactivation (or release) of cell discontinuous reception and/or cell discontinuous transmission, the cell discontinuous reception and/or cell discontinuous transmission is activated/deactivated (or released) after the UE transmits the PUCCH or PUSCH. Optionally, the PUCCH or PUSCH transmission is not cancelled. For example, the PUCCH or PUSCH transmission is not cancelled by a PUCCH or PUSCH transmission with a higher priority.

As an example, in case that the UE transmits a PUCCH or PUSCH transmission carrying the HARQ-ACK information that includes ACK information (or ACK bit) corresponding to the first information, the first information is applied after the UE transmits the PUCCH or PUSCH transmission.

As another example, in case that the UE transmits a PUCCH or PUSCH transmission carrying the HARQ-ACK information that includes ACK information (or ACK bit) corresponding to the first information, and the PUCCH or PUSCH transmission is not cancelled, the first information is applied after the UE transmits the PUCCH or PUSCH transmission. If the PUCCH or PUSCH transmission is cancelled, the first information is not applied.

In some implementations, the application of the first information after the UE transmits the PUCCH or PUSCH (e.g., after a last symbol (or ending position or symbol) of the PUCCH or PUSCH) may be that the first information is applied after a first number of time units (e.g., slots, subslots, symbols, and/or the like) after the UE transmits the PUCCH or PUSCH, or that the first information is applied in the first (or next) cycle of cell discontinuous reception and/or cell discontinuous transmission (the first (or next) cell DTX and/or cell DRX cycle) after the first number of time units (e.g., slots, subslots, symbols, and/or the like) after the UE transmits the PUCCH or PUSCH, where the first number may be specified by protocols or configured by higher layer signaling. The first number may be a non-negative integer or a rational number.

It should be noted that the feedback mode of the HARQ-ACK in this method may be HARQ-ACK feedback mode 1. The examples or details of HARQ-ACK feedback mode 1 may refer to the previous description about “HARQ-ACK feedback mode”.

The method may prevent the UE from transmitting or receiving data or control information during the non-active period, which can reduce the power consumption of the UE. In addition, the application time of the first information defined by the method is after the UE feeds back the ACK and the base station decodes the ACK, which can also make the understanding of discontinuous reception and/or cell discontinuous transmission between the UE and the base station consistent, thereby improving the communication reliability.

### Method MN2

Method MN2 may be obtained by modifying Method MN1, for example, by replacing “the first information is applied after the UE transmits the PUCCH or PUSCH” in Method MN1 with “the first information is applied after a PDCCH reception (or a candidate PDCCH reception) carried the first information”. In this way, the delay of the application of the first information can be reduced. Here, the same description as that of Method MN1 is omitted for the sake of brevity.

In some implementations, when the UE receives data and/or first information that indicates the information related to cell discontinuous reception and/or cell discontinuous transmission, and the first information is carried by a PDCCH, then the first information or information related to cell discontinuous reception and/or cell discontinuous transmission is applied after the PDCCH reception.

In some implementations, the application of the first information or the information related to cell discontinuous reception and/or cell discontinuous transmission after the PDCCH reception may be that the first information is applied after P time units (e.g., slots, subslots, symbols, milliseconds, seconds, and/or the like) after the UE receives the PDCCH, or that the first information is applied in the first (or next) cycle of cell discontinuous reception and/or cell discontinuous transmission (the first (or next) cell DTX and/or cell DRX cycle) or the first (or next) slot (for example, slot of a serving cell where the PDCCH is located; for another example, slot of a serving cell with a smallest SCS in an active BWP of the serving cell indicated by the first information) after P time units (e.g., slots, subslots, symbols, milliseconds, seconds, and/or the like) after the UE receives the PDCCH (e.g., the end position or end symbol of the PDCCH), or the time unit interval between the starting time (or position) of the cycle of cell discontinuous reception and/or cell discontinuous transmission (cell DTX and/or cell DRX cycle) to which the first information is applied and the PDCCH (e.g., the end position or end symbol of the PDCCH) is not less than P, or is greater than (or equal to) P. Here, the P may be specified by protocols or configured by higher layer signaling. The P may be a non-negative integer or a rational number.

In one example, P may be at least one of the following, or P may be the maximum of at least one of the following:
PUSCH preparation time;
UCI multiplexing or prioritization preparation time;
SP-CSI (semi-persistent CSI) preparation time;
P-CSI (periodic CSI) preparation time.

The PUSCH preparation time T_{proc,2} may be determined by the following equation 1.

T_{proc,2}=max(N₂+d_{2,1}+d₂)(2048+144)·κ2^{-μ}·T_{C}+Tₑₓₜ+T_{switch},d_{2,2}) [Equation 1]
The value of N₂ is determined by Table 3 and Table 4.
Tₑₓₜ is an additional time for operation with shared spectrum channel access.
d_{2,1} is a parameter related to DM-RS. For example, if the first symbol allocated by PUSCH only consists of DM-RS, d_{2,1}=0′ otherwise d_{2,1}=1.
d_{2,2} is a BWP switching time.
d₂ is an additional time when a PUSCH of a larger priority index (which may correspond to a higher priority) overlaps with a PUSCH of a smaller priority index (which may correspond to a lower priority). For example, d₂ may be a non-negative integer.
T_{switch} is an uplink switching gap.
κ is a constant, and κ=64
μ may be determined by subcarrier spacing parameters. For example, μ may be determined according to Table 5, where Δf is the subcarrier spacing.
Time unit T_{c}=1/(Δfₘₐₓ·N_{f}), where Δfₘₐₓ=480·10³ Hz and N_{f}=4096.

TABLE 3
PUSCH Preparation Time (for PUSCH timing capability 1)

| μ | PUSCH preparation time N₂ [symbols] |
|---|---|
| 0 | 10 |
| 1 | 12 |
| 2 | 23 |
| 3 | 36 |
| 5 | 144 |
| 6 | 288 |

TABLE 4
PUSCH Preparation Time (for PUSCH timing capability 2)

| μ | PUSCH preparation time N₂ [symbols] |
|---|---|
| 0 | 5 |
| 1 | 5.5 |
| 2 | 11 for frequency range 1 |

TABLE 5

| μ | Δf = 2^{μ} · 15 [kHz] |
|---|---|
| 0 | 15 |
| 1 | 30 |
| 2 | 60 |
| 3 | 120 |
| 4 | 240 |
| 5 | 480 |
| 6 | 960 |

If there is at least one PUSCH in a group of overlapping PUCCHs and PUSCHs, the UCI multiplexing preparation time

$${T}_{proc , 2}^{m u x}$$

is given by maximum of

$$\{ {T}_{p r o c , 2}^{m ux , 1} , … , {T}_{p r oc , 2}^{m ux , i} , … \} ,$$

where for the ith PUSCH which is in the group of overlapping PUCCHs and PUSCHs,

$${T}_{p roc , 2}^{mux , i} = max ( ( {N}_{2} + {d}_{2 , 1} + 1 ) \cdot ( 2048 + 1 \; 44 ) \cdot κ \cdot {2}^{- μ} \cdot {T}_{C} + {T}_{s w i 𝔠 c h} , {d}_{2 , 2} ) , {d}_{2 , 1} ,$$

d_{2,2} and T_{switch} correspond to the ith PUSCH, N₂ is selected based on the UE

PUSCH processing capability (e.g., PUSCH timing capability) of the ith PUSCH and SCS configuration u, where u corresponds to the smallest SCS configuration among the SCS configurations used for the PDCCH scheduling the i-th PUSCH, the PDCCHs scheduling the PDSCHs, or providing the DCI formats without scheduling PDSCHs, with corresponding HARQ-ACK information on a PUCCH which is in the group of overlapping PUCCHs/PUSCHs, and all PUSCHs in the group of overlapping PUCCHs and PUSCHs.

In some implementations, the first information may indicate activation and deactivation of discontinuous receptions and/or discontinuous transmissions of multiple cells, and the P values for activation and deactivation of discontinuous receptions and/or discontinuous transmissions of multiple cells may be independent (or different). This can improve the scheduling flexibility and reduce the delay. Alternatively, the P values for activation and deactivation of discontinuous receptions and/or discontinuous transmissions of multiple cells may be the same, which may be, for example, the P value for deactivation of cell discontinuous reception and cell discontinuous transmission. This can reduce the implementation complexity.

In some implementations, the first information may indicate activation/deactivation of cell discontinuous reception and cell discontinuous transmission, and the P values for activation/deactivation of cell discontinuous reception and cell discontinuous transmission may be independent (or different), which can improve the scheduling flexibility and reduce the delay. Alternatively, the P values for activation/deactivat ion of cell discontinuous reception and cell discontinuous transmission may be the same, which may be, for example, the maximum of the P values for activation/deactivation of cell discontinuous reception and cell discontinuous transmission, thereby reducing the implementation complexity. In some implementations, the first information may indicate activation/deactivation of cell discontinuous reception and/or cell discontinuous transmission of multiple cells, and the P values for activation/deactivation of cell discontinuous reception and/or cell discontinuous transmission of the multiple cells may be independent (or different). This can improve the scheduling flexibility and reduce the delay. Alternatively, the P values for activation/deactivation cell discontinuous reception and/or cell discontinuous transmission of multiple cells may be the same, which may be, for example, the maximum of the P value corresponding to each serving cell. This can reduce the implementation complexity.

In some implementations, the application of the first information after the PDCCH reception carrying the first information may be that the first information is applied immediately after the PDCCH reception carrying the first information.

In some cases, if the UE does not detect the first information (or the DCI format carrying the first information) in a PDCCH monitoring occasion (for example, the PDCCH monitoring occasion corresponding to the first information), the UE may assume at least one of the following:
the cell discontinuous reception is activated; this can reduce the power consumption of the UE.
the cell discontinuous reception is deactivated; this can prevent the base station from not receiving SR or CG PUSCH.
the cell discontinuous transmission is activated; this can reduce the power consumption of the UE.
the cell discontinuous transmission is deactivated; this can prevent the UE from missing PDCCH or not receiving SPS PDSCH.

In some implementations, one of the following may be configured by a first higher layer parameter:
the cell discontinuous reception is activated and cell discontinuous transmission is activated; or
the cell discontinuous reception is deactivated and the cell discontinuous transmission is deactivated.

This can improve the scheduling flexibility.

In some implementations, one of the following may be configured by a second higher layer parameter:
the cell discontinuous reception is activated; or
the cell discontinuous reception is deactivated.

Also, one of the following may be configured through a third higher layer parameter:
the cell discontinuous transmission is activated; or
the cell discontinuous transmission is deactivated.

This can further improve the scheduling flexibility.

It should be noted that the first higher-layer signaling parameter, the second higher-layer signaling parameter and the third higher-layer signaling parameter may be configured uniformly for multiple serving cells or separately for multiple serving cells. The unified configuration can reduce the signaling overhead of higher layers, while separate configuration can improve the scheduling flexibility.

In some implementations, the first information may indicate activation/deactivat ion of cell discontinuous reception and/or cell discontinuous transmission for multiple cells, and for each serving cell (for example, serving cell configured with cell discontinuous reception and/or cell discontinuous transmission), a bit position corresponding to activation/deactivation of the cell discontinuous transmission and a bit position corresponding to activation/deactivation of the cell discontinuous reception may be indicated respectively through RRC signaling. This can improve the scheduling flexibility. Alternatively, for a serving cell (for example, a serving cell configured with cell discontinuous reception and/or cell discontinuous transmission), a bit position corresponding to activation/deactivation of the discontinuous transmission (or reception) of the cell may be indicated by RRC signaling, and the bit position corresponding to activation/deactivation of the discontinuous reception (or transmission) for the serving cell is the next bit of the bit position corresponding to activation/deactivation of the discontinuous transmission (or reception) for the cell indicated by the RRC signaling. This can save the RRC signaling overhead.

In some implementations, for a serving cell, when the UE is not configured by higher layer signaling that activation/deactivation of cell discontinuous transmission and/or cell discontinuous reception is indicated in a DCI format (e.g., DCI format 2_9) carrying the first information, if bit position(s) in the DCI format (e.g., DCI format 2_9) carrying the first information is configured for the serving cell, the DCI format carrying the first information (e.g., DCI format 2_9) indicates activation/deactivation of cell discontinuous transmission and/or cell discontinuous reception for the serving cell, where the cell discontinuous transmission and/or cell discontinuous reception are determined by parameters for configuring cell discontinuous transmission and/or cell discontinuous reception for the cell. For example, if the cell discontinuous transmission for the serving cell is configured by higher layer signaling, the DCI format (e.g., DCI format 2_9) carrying the first information indicates activation/deactivation of the cell discontinuous transmission for the serving cell; if the cell discontinuous reception for the serving cell is configured by higher layer signaling, the DCI format (e.g., DCI format 2_9) carrying the first information indicates activation/deactivation of the cell discontinuous reception for the serving cell; if the cell discontinuous transmission and the cell discontinuous reception for the serving cell are configured by higher layer signaling, the DCI format (e.g., DCI format 2_9) carrying the first information indicates activation/deactivation of the cell discontinuous transmission and the cell discontinuous reception for the serving cell. The configured bit position corresponds to activation/deactivation of the cell discontinuous transmission for the serving cell, and the next bit of the configured bit position corresponds to activation/deactivation of the cell discontinuous reception for the serving cell.

This method can save the higher layer signaling overhead, thereby reducing the power of the base station and achieving the purpose of network power/energy saving.

It should be noted that the HARQ-ACK feedback mode in the method may be HARQ-ACK feedback mode 1 or HARQ-ACK feedback mode 2. Examples or details of HARQ-ACK feedback mode 1 or HARQ-ACK feedback mode 2 may refer to the previous description about “HARQ-ACK feedback mode”.

In case that the HARQ-ACK feedback mode is HARQ-ACK feedback mode 2, the first information is carried by a PDCCH, and the UE is configured by higher layer signaling to monitor the PDCCH carrying the first information in a predefined CORESET and/or search space (or search space set) and/or a PDCCH monitoring occasion. If the UE does not detect the PDCCH carrying the first information for a certain PDCCH monitoring occasion, the UE generates a 1-bit NACK. A slot of a PUCCH resource carrying the NACK may be determined from a candidate PDCCH (for example, a symbol where the candidate PDCCH is located or the monitoring occasion) and a time unit interval between the candidate PDCCH and the PUCCH, where the time unit is configured by higher layer signaling. The PUCCH resource may be configured by higher layer signaling as a separate PUCCH resource.

In some implementations, one of the Methods MN1 and MN2 may be configured through higher layer parameters.

### Method MN3

Method MN3 may be obtained by modifying Method MN1. For example, Method MN3 may be obtained by replacing “the first information is applied after the UE transmits the PUCCH or PUSCH” in Method MN1 with “the first information is applied after a PDCCH reception (or a candidate PDCCH reception) carrying the first information”. In this way, the delay of the application of the first information can be reduced. Here, the same description as that of Method MN1 is omitted for the sake of brevity.

In some implementations, in case that the UE receives data and/or the first information, where the first information may indicate the information related to cell discontinuous reception and/or cell discontinuous transmission, and is carried by a PDSCH, then the first information or the information related to cell discontinuous reception and/or cell discontinuous transmission is applied after the reception of the PDSCH.

In some implementations, the application of the first information after the PDSCH reception carrying the first information may be that the first information is applied after Q time units (e.g., slots, subslots, symbols, and/or the like) after the UE receives the PDSCH, or that the first information is applied after the first (or next) cycle of cell discontinuous reception and/or cell discontinuous transmission (the first (or next) cell DRX or cell DRT cycle) after Q time units after the UE receives the PDSCH, where the Q may be specified by protocols or configured by higher layer signaling. The Q may be a non-negative integer or a rational number.

In some implementations, the application of the first information after the PDSCH reception carrying the first information may be that the first information is applied immediately after the PDSCH reception carrying the first information.

In some implementations, one of the Methods MN1, MN2 or MN3 may be configured by a higher layer parameter. For example, one of MN1, MN2 or MN3 may be configured uniformly for cell discontinuous reception and discontinuous transmission by a higher layer parameter (or a set of higher layer parameters). Alternatively, one of MN1, MN2 or MN3 may be configured separately for cell discontinuous reception and discontinuous transmission by two (or different) higher layer parameters (or sets of higher layer parameters). This can improve the scheduling flexibility.

In a non-active period (for example, a non-active period of cell DTX), the UE may not receive a PDCCH. If a TB or CBG in the PDCCH is not decoded successfully, the UE feeds back a NACK for the TB or CBG, and the UE may have to wait until the next active period to continue monitoring the PDCCH, which may increase the delay.

### Method MN4

In Method MN4, the UE transmits a PUCCH or PUSCH with HARQ-ACK information. If a NACK is included in the HARQ-ACK information, the UE monitors a PDCCH after the transmission of the PUCCH or PUSCH, or a third time (or time unit) after the transmission of the PUCCH or PUSCH is determined as an active period. Or, the UE starts a first timer after the transmission of the PUCCH or PUSCH, and the active period may include a time when the first timer is running, or the UE monitors a PDCCH when the first timer is running. The first timer may be a time when the UE monitors a PDCCH or an extended active period. For example, when the first timer is running, the UE may monitor a PDCCH, or the UE may be in the active period.

In some implementations, “if a NACK is included in the HARQ-ACK information” may be replaced with “if a first predefined NACK is included in the HARQ-ACK information”. Or, “if a NACK is included in the HARQ-ACK information” may be replaced with “a NACK other than a second predefined NACK is included in the HARQ-ACK information”. For example, the first predefined NACK may be a NACK generated due to DCI missing detection. The second predefined NACK may be a NACK padded by the UE. For example, when a number of TBs or CBGs in a PDSCH scheduled by a DCI format is less than a number of HARQ-ACK bits corresponding to the DCI format, NACK bit(s) is (are) padded.

In some implementations, “the UE monitoring a PDCCH after the transmission of the PUCCH or PUSCH, or a third time (or time unit) after the transmission of the PUCCH or PUSCH being determined as an active period” may be that the UE monitors the PDCCH after a second number of time units after the transmission of the PUCCH or PUSCH, or the third time (or time unit) after the second number of time units after the transmission of the PUCCH or PUSCH is determined as the active period, where the N may be specified by protocols or configured by a higher layer signaling. The second number may be a non-negative integer or a rational number. “The UE starts a first timer after the transmission of the PUCCH or PUSCH” may be that the UE starts the first timer after the second number of time units after the transmission of the PUCCH or PUSCH.

In some implementations, “the UE starts a first timer after the transmission of the PUCCH or PUSCH” may be that the UE starts the second timer after the transmission of the PUCCH or PUSCH, and starts the first timer when the second timer expires. Here, the second timer may be a time that the UE waits for the transmission of a PDCCH.

The first timer and/or the second timer may be configured by higher layer parameters.

As some examples, the first predefined NACK may include at least one of the following:
a NACK corresponding to a TB or a CBG. For example, if the TB or CBG is not decoded correctly, the UE generates the one-bit NACK.
a NACK corresponding to a PDSCH. For example, if a TB or CBG in the PDSCH is not decoded correctly, the UE generates the one-bit NACK.
a NACK corresponding to a PDSCH (or PDCCH/DCI format) that is not received. For example, the UE does not receive the PDSCH because the UE does not detect the PDCCH/DCI format (for example, in case that the PDCCH/DCI format is transmitted by the base station).
a NACK generated for a missing DCI format, in case that the UE is configured with a Type-2 HARQ-ACK codebook.
a NACK included in a Type-2 HARQ-ACK codebook.
a NACK included in a Type-3 HARQ-ACK codebook.

As some examples, when the UE is configured with a Type-2 HARQ-ACK codebook, the NACK generated for the missing DCI format by the UE may include a NACK generated in case that at least one of the following is satisfied:
a value of a C-DAI is not continuous. For example, according to an order for the definition of the C-DAI, the values of the C-DAIs in two continuous DCI formats are not continuous. The order of DCI formats may be determined according to the order for the definition of the C-DAI. It should be noted that if the value of the C-DAI in a first DCI format is 4 and the value of the C-DAI in a second DCI format is 1, it may be considered that the value of the C-DAI is continuous. If the value of the C-DAI in the first DCI format is n, where n is an integer less than 4, and the value of the C-DAI in the second DCI format is n+1, it may be considered that the value of the C-DAI is continuous, otherwise, the value of the C-DAI is not continuous.
a value of a C-DAI in a last DL DCI format among DL DCI formats received in a PDCCH monitoring occasion is not equal to a value of a T-DAI.
a value of a C-DAI in a last DL DCI format among DL DCI formats received in a last PDCCH monitoring occasion is not equal to a value of a UL T-DAI.
a T-DAI in a DL DCI format received in a last PDCCH monitoring occasion is not equal to a value of a UL T-DAI.
O^{ACK} is not equal to a number of elements in Vₛ.
Vₜₑₘₚ₂ is not equal to

$${V}_{T - DAI}^{UL}$$

after performing a pseudo code used to generate a HARQ-ACK codebook (e.g., pseudo-code 1 described above)
Vₜₑₘₚ₁ is not equal to

$${V}_{T - DAI}^{UL}$$

after performing a pseudo code used to generate a HARQ-ACK codebook (e.g., pseudo-code 1 described above)

For example, for one or more DL DCI formats received in a PDCCH monitoring occasion, a last DL DCI format may be a DCI format with a largest index of a serving cell (largest serving cell index) among the one or more DL DCI formats, where the serving cell is a serving cell where a PDSCH scheduled by the DCI format is located.

For example, the UL T-DAI may be a UL T-DAI in a DCI format that schedules a PUSCH with HARQ-ACK information.

As some examples, the second predefined NACK may include a NACK generated in case that at least one of the following is satisfied:
the UE is not configured with a parameter related to HARQ-ACK spatial bundling (for example, 3GPP parameter harq-ACK-SpatialBundlingPUCCH) and for at lesast one active downlink BWP of a serving cell, the UE is configured (for example, by 3GPP parameter maxNrofCode WordsScheduledByDCI) to receive two transport blocks (TBs), and the UE receives a PDSCH including only one TB. The UE generates a 1-bit NACK for the second TB of the PDSCH.
a number N of CBGs in a PDSCH (or CBGs included in TB in PDSCH) received by the UE is less than a maximum value Nmax of a number of CBGs that can be scheduled in a DCI format (or a number of CBGs that can be included in one TB), and the UE generates Nmax-N bit NACK.

The method can improve the reliability of downlink transmission, so that the active period is extended in the case of missing detection of DCI, and the UE can monitor a PDCCH during the extended active period, which can avoid the situation that the base station extends the active period while the UE does not detect a PDCCH, thereby improving the reliability of transmission.

### Method MN5

In some cases, if HARQ-ACK information for the first information and HARQ-ACK information for other PDSCH(s) or DCI format(s) are indicated to be transmitted in a same slot, the HARQ-ACI information in the same slot may be multiplexed in a HARQ-ACK codebook by the UE.

In some implementations, a bit may be appended to the HARQ-ACK codebook including the HARQ-ACK information for other PDSCH(s) or DCI format(s) (for example, one bit is appended at the end of the HARQ-ACK codebook) to feed back whether the first information is received (or decoded correctly). It may be specified by protocols or configured by higher layer signaling whether the appended one bit is always in the HARQ-ACK codebook, or that the appended 1 bit is included in the HARQ-ACK codebook only if the UE receives the first information.

In this way, the ordering and size of HARQ-ACK bits can be defined, thereby improving the reliability of uplink transmission.

### Method MN6

In some cases, the UE may transmit two or more PUSCHs (two PUSCHs are taken as an example to explain below) at the same time. For example, the two PUSCHs may be on a same serving cell. For another example, the two PUSCHs may be in a same BWP. For another example, the two PUSCHs may be associated with two different TRPs/panels/beams. For another example, the UE may transmit the two PUSCHs through two different panels. The UE may be configured or indicated with simultaneous transmission of two PUSCHs (for example, two PUSCHs on a serving cell or a BWP). In this case, the UE may transmit two PUSCHs simultaneously or be allowed to transmit two PUSCHs simultaneously. In some examples, the UE may be configured with a parameter indicating simultaneous transmission of two PUSCHs (e.g., two PUSCHs on a serving cell or a BWP). If the UE is configured with the parameter indicating simultaneous transmission of two PUSCHs, the UE can simultaneously transmit two PUSCH. In some examples, the UE may be configured by a PDCCH configuration parameter (e.g., higher layer parameter PDCCH-Config), where the PDCCH configuration parameter (e.g., higher layer parameter, PDCCH-Config) includes two different values (e.g., value 0 and value 1) of a CORESET pool index parameter (e.g., coresetPoolIndex) in a control resource set parameter (e.g., ControlResourceSet). In this case, the UE can simultaneously transmit two PUSCHs on a serving cell or a BWP (for example, the two PUSCHs may correspond to different CORESET pool index parameter (e.g., coresetPoolIndex) values). The configuration of the control resource set parameter may be configuration of the control resource set parameter for an active BWP of a serving cell. In some examples, the UE may be configured or provided with an SRS resource set index parameter (e.g., SRS_resource_set_index) with two different values (e.g., value 0 and value 1). The first SRS resource set (of which the SRS resource set index parameter value is equal to 0) may correspond to the CORESET pool index parameter of value 0, and the other SRS resource set (of which the SRS resource set index parameter value is equal to 1) may correspond to the CORESET pool index parameter of value 1. In this case, the UE can simultaneously transmit two PUSCHs on a serving cell or a BWP (for example, the two PUSCHs may correspond to different SRS resource set index parameter (e.g., SRS_resource_set_index) values). The uplink transmission of multi-panel/multi-antenna/multi-beam configured for the UE is described above by taking the SRS resource set index parameter and the CORESET pool index parameter as examples. However, the example embodiments of the disclosure are not limited to this, and the uplink transmission of multi-panel/multi-antenna/multi-beam may be configured by other parameters associated with uplink (e.g., PUSCH) transmission. Although the above is described by taking simultaneous transmission of two PUSCHs as examples, the example embodiments of the disclosure are not limited to this, and similar methods may be adopted for configuring (for example, configuring N CORESET pool index parameter values, where N is an integer equal to or greater than 2), so that the UE can or supports transmitting N PUSCHs simultaneously. Similarly, the UE may receive two or more PDSCHs simultaneously.

In some implementations, the first information may be configured separately for different CORESET pool index parameter (e.g., coresetPoolIndex) values of a serving cell. For example, one or more of parameters such as a cycle, a starting slot (or offset), an activity duration (a period of activity), or a timer may be configured separately for different CORESET pool index parameter (e.g., coresetPoolIndex) values of a serving cell. For another example, the first information (for example, activation/deactivation of cell DTX or cell DRX) corresponding to different CORESET pool index parameters (e.g., coresetPoolIndex values) of a serving cell may be indicated by different fields in a DCI format, respectively. This can improve the scheduling flexibility of the base station, and avoid that when a TRP is activated, cell DTX/DRX of another TRP cannot be activated, thereby improving the gain of the network energy saving.

In some cases, the UE may receive third information, which indicates an ACK NACK feedback mode (ackNackFeedbackMode). For example, the UE may receive the third information from the base station. For example, the third information may indicate whether the ACK NACK feedback mode (ackNackFeedbackMode) is a separate feedback (ackNackFeedbackMode=separate) or a joint feedback (ackNackFeedbackMode=joint). As an example, the separate feedback may correspond to a feedback mode in which the UE cannot or is not allowed to multiplex UCI of a PUCCH (e.g., with the first CORESET pool index parameter value) associated with a first CORESET (e.g., the first CORESET pool index parameter value) in a PUSCH (e.g., with the second CORESET pool index parameter value) associated with a second CORESET (e.g., the second CORESET pool index parameter value). The joint feedback may correspond to a feedback mode in which the UE can or is allowed to multiplex UCI of a PUCCH (e.g., with the first CORESET pool index parameter value) associated with a first CORESET (e.g., the first CORESET pool index parameter value) in a PUSCH (e.g., with the second CORESET pool index parameter value) associated with a second CORESET (e.g., the second CORESET pool index parameter value).

If the third information indicates the ACK NACK feedback mode (ackNackFeedbackMode) as joint, the first information (e.g., activation/deactivation of cell DTX or DRX) corresponding to different COREST pool index parameter (e.g., coresetPoolIndex) values of a serving cell may be indicated by different fields in a DCI format, respectively. If the third information indicates the ACK NACK feedback mode (ackNackFeedbackMode) as separate, only the first information (e.g., activation/deactivation of cell DTX or DRX) associated with the coresetPoolIndex parameter (e.g., coresetPoolIndex) value corresponding to a DCI format may be indicated in the DCI format. It should be noted that the third information may also be replaced by a new higher layer parameter to indicate whether a DCI format contains the first information (for example, activation/deactivation of cell DTX or DRX) corresponding to different CORESET pool index parameter (e.g., coresetPoolIndex) values. This can further improve the scheduling flexibility and improve the efficiency of network energy saving.

### Method MN7

In operation S710, the UE may receive eleventh information from the base station, where the eleventh information may be downlink control signaling. For example, the eleventh information may be configuration information carried by higher layer signaling. The eleventh information is used to configure configuration information related to an eleventh physical channel. The eleventh physical channel may be a cell (e.g., serving cell) specific (or common) physical channel. For example, the eleventh physical channel is a physical channel common to all UEs in a cell.

In operation S710, the UE may receive twelfth information from the base station, where the twelfth information may be downlink control signaling. For example, the twelfth information may be configuration information carried by higher layer signaling. The twelfth information is used to configure configuration information related to a twelfth physical channel. The twelfth physical channel may be a group common physical channel. For example, the twelfth physical channel is a physical channel common to a group of UEs. If all UEs in a cell are configured in a same group, the twelfth physical channel may also be a cell (e.g., serving cell) specific (or common) physical channel.

In some implementations, the eleventh physical channel may be at least one of SSB, PRACH, Paging, PSS and SSS. The eleventh physical channel includes an eleventh physical downlink channel and an eleventh physical uplink channel, where the eleventh physical downlink channel may be at least one of SSB, Paging, PSS and SSS, and the eleventh physical uplink channel may be PRACH.

In some implementations, the twelfth physical channel may be at least one of SSB, PRACH, Paging, PSS and SSS. The twelfth physical channel includes a twelfth physical downlink channel and a twelfth physical uplink channel, where the twelfth physical downlink channel may be at least one of SSB, Paging, PSS and SSS, and the twelfth physical uplink channel may be PRACH.

In one example, the eleventh physical channel may be SSB, and the twelfth physical channel may be at least one of SSB, PSS and SSS.

The eleventh information may be configured in a serving cell common configuration IE (e.g., ServingCellConfigCommon) or a serving cell common configuration SIB IE (e.g., ServingCellConfigCommonSIB), and the eleventh information may include at least one of the following:
a periodicity of SSBs on a serving cell, e.g., the parameter ssb-periodicityServingCell. In the embodiments of the disclosure, it may be called “eleventh period”.
a SS-PBCH block power, e.g., the parameter ss-PBCH-BlockPower
a subcarrier spacing of SSBs, e.g., the parameter ssbSubcarrierSpacing
positions of SSBs in a SSB burst, e.g., the parameter ssb-PositionsInBurst
QCL positions of SSBs, for example, the parameter ssb-PositionQCL.

The twelfth information may be configured in a serving cell configuration IE (e.g., ServingCellCommon). The twelfth information may include at least one of the following:
a second period and/or a second offset of the twelfth physical channel, where the second period of the twelfth physical channel may be called “twelfth period” in the embodiments of the disclosure. The second offset may be a time interval between the twelfth physical channel (e.g., the starting position or starting symbol of the twelfth physical channel) and a reference in a twelfth period. For example, the reference may be the start (or the starting time) of a time unit (e.g., the first time unit). The time unit may be a frame or a half frame. The reference may also be the start (or starting time) of the eleventh physical channel. As an example, the reference may be the start (or starting time) of the eleventh physical channel in a time unit (e.g., the first time unit). As another example, the reference may be the start (or starting time) of the eleventh physical channel in an eleventh period. Optionally, the eleventh period may be a eleventh period with the same starting time as the twelfth period.
a power of the twelfth physical channel
a subcarrier spacing of the twelfth physical channel
positions of the twelfth physical channel in a burst
QCL positions of the twelfth physical channel
positions of the twelfth physical channel in the eleventh period
an absolute frequency of the twelfth physical channel (e.g., the parameter absoluteFrequencySSB-r17 or the parameter absoluteFrequencySSB-r19).
a third period and/or a third offset of the twelfth physical channel. The third period of the twelfth physical channel may be different from the second period of the twelfth physical channel.

In some implementations, it may be configured by higher layer signaling and/or indicated by DCI that the period of the twelfth physical channel is switched between the second period of the twelfth physical channel and the third period of the twelfth physical channel. In this way, a larger period may be adopted in case that data is not frequent, thereby reducing the power of the UE receiving the twelfth physical channel.

In operation S710, the UE may receive thirteenth information from the base station, where the thirteenth information may be downlink control signaling. For example, the thirteenth information may be configuration information carried by higher layer signaling. The thirteenth information is used to configure configuration information related to first cell (e.g., serving cell) DRX/DTX. For example, the thirteenth information may be configuration information (e.g., the parameter cellDTXDRX-Config-r18) related to cell (e.g., serving cell) DRX/DTX for UE-specific channels.

In operation S710, the UE may receive fourteenth information from the base station, where the fourteenth information may be downlink control signaling. For example, the fourteenth information may be configuration information carried by higher layer signaling. The fourteenth information is used to configure configuration information related to second cell (e.g., serving cell) DRX/DTX. For example, the fourteenth information may be configuration information (e.g., the parameter cellDTXDRX-Config-r19) related to cell (e.g., serving cell) DRX/DTX for a common channel (e.g., group common channel or cell common channel). The fourteenth information may include a parameter of an activity timer for the second cell DTX/DRX, for example, the parameter celldtxdrx-onDurationTimer-r19.

In some implementations, when the second cell DTX for a serving cell is configured and activated, an active period of the second cell DTX includes a time when the activity timer for the second cell DTX/DRX is running.

In some implementations, when the first cell DTX for a serving cell is configured and activated, an active period of the first cell DTX includes a time when an activity timer for the first cell DTX/DRX is running.

In some implementations, the UE does not receive the twelfth physical downlink channel within a time that is not the active period of the second cell DTX. This can reduce the power consumption of the UE. Also, this can avoid the influence on the UE that does not support this function.

In some implementations, in operation S710, the UE may also receive fifteenth information from the base station, where the fifteenth information may be used to indicate that the twelfth physical downlink channel is not received by the UE within a time that is not the active period of the first cell DTX. For example, if the UE is configured with the fifteenth information, the UE does not receive the twelfth physical downlink channel within a time that is not the active period of the first cell DTX. This can reduce the power consumption of the UE. Also, this can avoid the influence on the UE that does not support this function.

It should be noted that the method applicable to the reception of physical downlink channels in the embodiments of the disclosure may also be applicable to the transmission of physical uplink channels. For example, in the method, “cell DTX” may be replaced by “cell DRX”, “downlink channel” can be replaced by “uplink channel”, and “receive” may be replaced by “transmit”.

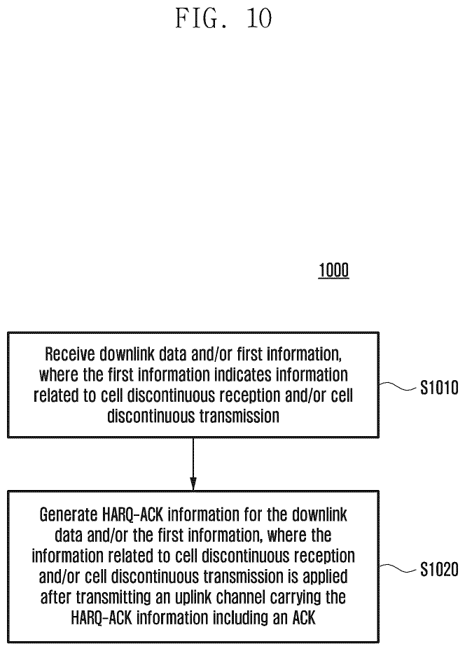

FIG. 10 illustrates a flowchart of a method performed by a terminal according to some embodiments of the disclosure.

Referring to FIG. 10, in operation S1010, the terminal receives downlink data and/or first information, where the first information indicates information related to cell discontinuous reception and/or cell discontinuous transmission.

Next, in operation S1020, the terminal generates HARQ-ACK information for the downlink data and/or the first information, where the information related to cell discontinuous reception and/or cell discontinuous transmission is applied after transmitting an uplink channel carrying the HARQ-ACK information including an ACK.

In some implementations, one or more of operations S1010 to S1020 may be performed based on methods described according to various embodiments of the disclosure (for example, the example embodiments described in connection with FIGS. 4-7, and various methods described above, such as in Methods MN1-MN5).

In some implementations, the method 1000 may omit one or more of operations S1010 to S1020, or may include additional operations, for example, the operations that can be performed by a terminal (e.g., a UE) described according to various embodiments of the disclosure (e.g., the example embodiments described in connection with FIGS. 4-7, and various methods described above, such as Methods MN1-MN5).

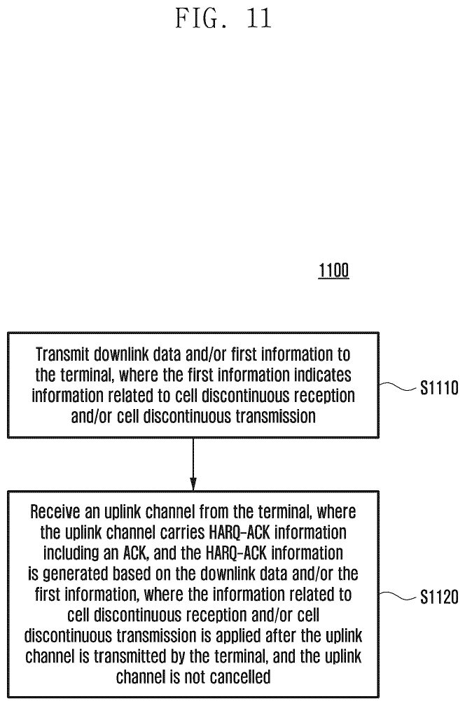

FIG. 11 illustrates a flowchart of a method performed by a base station according to some embodiments of the disclosure.

Referring to FIG. 11, in operation S1110, the base station transmits downlink data and/or first information to the terminal, where the first information indicates information related to cell discontinuous reception and/or cell discontinuous transmission.

Next, in operation S1120, the base station receives an uplink channel from the terminal, where the uplink channel carries HARQ-ACK information including an ACK, and the HARQ-ACK information is generated based on the downlink data and/or the first information, where the information related to cell discontinuous reception and/or cell discontinuous transmission is applied after the uplink channel is transmitted by the terminal, where the uplink channel is not cancelled.

In some implementations, one or more of S1110 to S1120 may be performed based on the methods described according to various embodiments of the disclosure (for example, the example embodiments described in connection with FIGS. 4-7, and various methods described above, such as in Methods MN1-MN5).

In some implementations, the method 1100 may omit one or more of operations S1110 to S1120, or may include additional operations, for example, the operations that can be performed by a base station according to various embodiments of the disclosure (e.g., the example embodiments described in connection with FIGS. 4-7, and various methods described above, such as Methods MN1-MN5).

According to an embodiment, a method performed by a terminal in a wireless communication system is provided.

According to an embodiment, the method includes receiving downlink data and/or first information, wherein the first information indicates information related to cell discontinuous reception and/or cell discontinuous transmission; generating hybrid automatic repeat request-acknowledgement (HARQ-ACK) information for the downlink data and/or the first information, wherein the information related to cell discontinuous reception and/or cell discontinuous transmission is applied after transmitting an uplink channel carrying the HARQ-ACK information including an acknowledgement (ACK), and wherein the uplink channel is not cancelled.

According to an embodiment, wherein: the information related to cell discontinuous reception and/or cell discontinuous transmission is applied after a first number of time units after transmitting the uplink channel; or the information related to cell discontinuous reception and/or cell discontinuous transmission is applied in a cycle related to discontinuous reception and/or cell discontinuous transmission after the first number of time units after transmitting the uplink channel.

According to an embodiment, the method further includes, in case that the HARQ-ACK information includes a negative acknowledgement (NACK): monitoring a physical downlink control channel (PDCCH) after transmitting the uplink channel, and/or starting a first timer after transmitting the uplink channel, wherein the first timer is used to indicate one or more of a time that the terminal monitors the PDCCH or an active period of the terminal.

According to an embodiment, wherein, in case that the HARQ-ACK information includes the NACK: the PDCCH is monitored after a second number of time units after transmitting the uplink channel, and/or the first timer after the second number of time units is started after transmitting the uplink channel.

According to an embodiment, the method further includes: starting a second timer after transmitting the uplink channel, wherein the second timer is used to indicate a time that the terminal waits for to receive the PDCCH, wherein the first timer is started when the second timer expires.

According to an embodiment, wherein the NACK includes one or more of: a NACK corresponding to a transport block or a code block group; a NACK corresponding to a physical downlink shared channel (PDSCH); a NACK corresponding to a PDSCH that is not received; a NACK generated for a missing downlink control information (DCI) format; a NACK included in a HARQ-ACK codebook; or a NACK other than padded NACKs.

According to an embodiment, wherein, in case that a Type-2 HARQ-ACK codebook is configured, the NACK generated for the missing DCI format includes one or more of the following: a NACK generated based on a counter downlink allocation index (C-DAI) being discontinuous; a NACK generated based on a value of a C-DAI in a last downlink (DL) DCI format among one or more DL DCI formats being not equal to a value of a total DAI (T-DAI), where the one or more DL DCI formats are received in any PDCCH monitoring occasion; a NACK generated based on a value of a C-DAI in a last DL DCI format among one or more DL DCI formats being not equal to a value of an uplink (UL) T-DAI, where the one or more DL DCI formats are received in a last PDCCH monitoring occasion; or a NACK generated based on a value of a T-DAI in a DL DCI format received in the last PDCCH monitoring occasion being not equal to a value of a UL T-DAI.

According to an embodiment, wherein the last DL DCI format is a DL DCI format with a largest index of a serving cell among the one or more DL DCI formats received in the PDCCH monitoring occasion, wherein the serving cell is a serving cell where a PDSCH scheduled by the DL DCI format is located.

According to an embodiment, wherein the UL T-DAI is a UL T-DAI in a DCI format that schedules a physical uplink shared channel (PUSCH) carrying the HARQ-ACK information.

According to an embodiment, wherein the first information is carried by a downlink channel, and wherein the information related to cell discontinuous reception and/or cell discontinuous transmission is applied after receiving the downlink channel.

According to an embodiment, wherein: the information related to cell discontinuous reception and/or cell discontinuous transmission is applied in a cycle related to discontinuous reception and/or cell discontinuous transmission after a third number of time units after receiving the downlink channel; or the information related to cell discontinuous reception and/or cell discontinuous transmission is applied after the third number of time units after receiving the downlink channel.

According to an embodiment, wherein the information related to cell discontinuous reception and/or cell discontinuous transmission includes one or more of: first indication information that is used to indicate activation and/or deactivation of cell discontinuous reception and/or cell discontinuous transmission; second indication information that is used to indicate modification of a parameter related to cell discontinuous reception and/or cell discontinuous transmission; or third indication information that is used to indicate whether to start a third timer of next one or more cycles related to cell discontinuous reception and/or cell discontinuous transmission.

According to an embodiment, wherein the first information is carried by a downlink channel, which includes a PDCCH and/or a PDSCH, and wherein the uplink channel includes a physical uplink control channel (PUCCH) and/or a PUSCH.

According to an embodiment, a method performed by a base station in a wireless communication system is provided.

According to an embodiment, the method includes: transmitting downlink data and/or first information to a terminal, wherein the first information indicates information related to cell discontinuous reception and/or cell discontinuous transmission; and receiving an uplink channel from the terminal, wherein the uplink channel carries hybrid automatic repeat request-acknowledgement (HARQ-ACK) information including an acknowledgement (ACK), wherein the HARQ-ACK information is generated based on the downlink data and/or the first information, wherein the information related to cell discontinuous reception and/or cell discontinuous transmission is applied after an uplink channel carrying the HARQ-ACK information including an acknowledgement (ACK) is transmitted by the terminal, and wherein the uplink channel is not cancelled.

According to an embodiment, wherein the information related to cell discontinuous reception and/or cell discontinuous transmission is applied in a cycle related to discontinuous reception and/or cell discontinuous transmission after a first number of time units after the uplink channel is transmitted by the terminal.

According to an embodiment, wherein the first information is carried by a downlink channel, wherein the information related to cell discontinuous reception and/or cell discontinuous transmission is applied after the downlink channel is received by the terminal.

According to an embodiment, wherein: the information related to cell discontinuous reception and/or cell discontinuous transmission is applied in a cycle related to discontinuous reception and/or cell discontinuous transmission after a third number of time units after the downlink channel is received by the terminal; or the information related to cell discontinuous reception and/or cell discontinuous transmission is applied after the third number of time units after the downlink channel is received by the terminal.

According to an embodiment, wherein the information related to cell discontinuous reception and/or cell discontinuous transmission includes one or more of: first indication information that is used to indicate activation and/or deactivation of cell discontinuous reception and/or cell discontinuous transmission; second indication information that is used to indicate modification of a parameter related to cell discontinuous reception and/or cell discontinuous transmission; or third indication information that is used to indicate whether to start a third timer of next one or more cycles related to cell discontinuous reception and/or cell discontinuous transmission.

According to an embodiment, a method performed by a user equipment (UE) in a communication system is provided.

According to an embodiment, the method includes receiving, via higher layer signaling, a first configuration of at least one of cell discontinuous transmission (DTX) or cell discontinuous reception (DRX) and a second configuration of a bit position associated with information of downlink control information (DCI); receiving the DCI; and identifying the information from the DCI based on the second configuration, wherein the information indicates activation or deactivation of the at least one of the cell DTX or the cell DRX configured by the first configuration.

According to an embodiment, wherein in case that the cell DTX and the cell DRX are configured by the first configuration, a bit on the bit position indicates activation or deactivation of the cell DTX and a next bit of the bit indicates activating or deactivating of the cell DRX.

According to an embodiment, wherein in case that one of the cell DTX or the cell DRX is configured by the first configuration, a bit on the bit position indicates activation or deactivation of the one of the cell DTX or the cell DRX.

According to an embodiment, wherein the activation or the deactivation indicated by the information is applied after a number of slots after a physical downlink control channel (PDCCH) including the DCI is received.

According to an embodiment, wherein the first configuration and the second configuration are configured for a serving cell.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logic blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described function sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, multiple microprocessors, one or more microprocessors cooperating with a DSP core, or any other such configuration.

The steps of the method or algorithm described in this application may be embodied directly in hardware, in a software module executed by a processor, or in a combination thereof. The software module may reside in a RAM memory, a flash memory, a ROM memory, an EPROM memory, an EEPROM memory, a register, a hard disk, a removable disk, or any other form of storage medium known in the art. An exemplary storage medium is coupled to a processor to enable the processor to read and write information from/to the storage medium. In an alternative, the storage medium may be integrated into the processor. The processor and the storage medium may reside in an ASIC. The ASIC may reside in a communication apparatus (e.g., a terminal or a base station). In an alternative, the processor and the storage medium may reside in a communication apparatus (e.g., a terminal or a base station) as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that may be accessed by a general purpose or special purpose computer.

The above description is only an exemplary implementation of the present invention, and is not intended to limit the scope of protection of the present invention, which is determined by the appended claims.

1. A method performed by a user equipment (UE) in a communication system, the method comprising:
receiving, via higher layer signaling, a first configuration of at least one of cell discontinuous transmission (DTX) or cell discontinuous reception (DRX) and a second configuration of a bit position associated with information of downlink control information (DCI);
receiving the DCI; and
identifying the information from the DCI based on the second configuration, wherein the information indicates activation or deactivation of the at least one of the cell DTX or the cell DRX configured by the first configuration.

2. The method of claim 1, wherein in case that the cell DTX and the cell DRX are configured by the first configuration, a bit on the bit position indicates activation or deactivation of the cell DTX and a next bit of the bit indicates activating or deactivating of the cell DRX.

3. The method of claim 1, wherein in case that one of the cell DTX or the cell DRX is configured by the first configuration, a bit on the bit position indicates activation or deactivation of the one of the cell DTX or the cell DRX.

4. The method of claim 1, wherein the activation or the deactivation indicated by the information is applied after a number of slots after a physical downlink control channel (PDCCH) including the DCI is received.

5. The method of claim 1, wherein the first configuration and the second configuration are configured for a serving cell.

6. A user equipment (UE) in a communication system, the UE comprising:
a transceiver; and
a processor coupled with the transceiver and configured to:
receive, via higher layer signaling, a first configuration of at least one of cell discontinuous transmission (DTX) or cell discontinuous reception (DRX) and a second configuration of a bit position associated with information of downlink control information (DCI);
receive the DCI; and
identify the information from the DCI based on the second configuration, wherein the information indicates activation or deactivation of the at least one of the cell DTX or the cell DRX configured by the first configuration.

7. The UE of claim 6, wherein in case that the cell DTX and the cell DRX are configured by the first configuration, a bit on the bit position indicates activation or deactivation of the cell DTX and a next bit of the bit indicates activating or deactivating of the cell DRX.

8. The UE of claim 6, wherein in case that one of the cell DTX or the cell DRX is configured by the first configuration, a bit on the bit position indicates activation or deactivation of the one of the cell DTX or the cell DRX.

9. The UE of claim 6, wherein the activation or the deactivation indicated by the information is applied after a number of slots after a physical downlink control channel (PDCCH) including the DCI is received.

10. The UE of claim 6, wherein the first configuration and the second configuration are configured for a serving cell.

11. A method performed by a base station in a communication system, the method comprising:
transmitting, via higher layer signaling, a first configuration of at least one of cell discontinuous transmission (DTX) or cell discontinuous reception (DRX) and a second configuration of a bit position associated with information of downlink control information (DCI); and
transmitting the DCI including the information,
wherein the information indicates activation or deactivation of the at least one of the cell DTX or the cell DRX indicated by the first configuration.

12. The method of claim 11, wherein in case that the cell DTX and the cell DRX are indicated by the first configuration, a bit on the bit position indicates activation or deactivation of the cell DTX and a next bit of the bit indicates activating or deactivating of the cell DRX.

13. The method of claim 11, wherein in case that one of the cell DTX or the cell DRX is indicated by the first configuration, a bit on the bit position indicates activation or deactivation of the one of the cell DTX or the cell DRX.

14. A base station in a communication system, the base station comprising:
a transceiver; and
a processor coupled with the transceiver and configured to:
transmit, via higher layer signaling, a first configuration of at least one of cell discontinuous transmission (DTX) or cell discontinuous reception (DRX) and a second configuration of a bit position associated with information of downlink control information (DCI); and
transmit the DCI including the information,
wherein the information indicates activation or deactivation of the at least one of the cell DTX or the cell DRX indicated by the first configuration.

15. The method of claim 11, wherein in case that the cell DTX and the cell DRX are indicated by the first configuration, a bit on the bit position indicates activation or deactivation of the cell DTX and a next bit of the bit indicates activating or deactivating of the cell DRX, and
wherein in case that one of the cell DTX or the cell DRX is indicated by the first configuration, the bit on the bit position indicates activation or deactivation of the one of the cell DTX or the cell DRX.
